(19) United States
(12) Patent Application Publication
(10) Pub. No.: US 2010/0297453 A1
(43) Pub. Date: Nov. 25, 2010

(54) INSULATING SHEET AND MULTILAYER STRUCTURE

(76) Inventors: Hiroshi Maenaka, Osaka (JP); Yasunari Kusaka, Osaka (JP); Takuji Aoyama, Osaka (JP); Isao Higuchi, Osaka (JP); Daisuke Nakajima, Osaka (JP); Takashi Watanabe, Osaka (JP)

Correspondence Address: Cheng Law Group, PLLC, 1100 17th Street, N.W., Suite 503, Washington, DC, 20036, US

(21) Appl. No.: 12/676,435

(22) PCT Filed: Sep. 2, 2008
(86) PCT No.: PCT/JP2008/065763

§ 371 Date: May 25, 2010

(30) Foreign Application Priority Data
Sep. 5, 2007 (JP) 2007-230482
Dec. 14, 2007 (JP) 2007-323527
Dec. 20, 2007 (JP) 2007-329140
Mar. 24, 2008 (JP) 2008-076347
Mar. 25, 2008 (JP) 2008-078796
Mar. 25, 2008 (JP) 2008-078797

(51) Int. Cl. B32B 15/08; B32B 27/38; C08L 73/00; C08L 29/00; C08K 7/00; C08K 3/22; C08K 3/38; C08K 3/28

(52) U.S. Cl. 428/418; 428/413; 524/540; 524/502; 523/220; 524/437; 524/404; 524/428; 524/443; 524/432; 524/433

(57) ABSTRACT

The present invention provides an insulating sheet which is used for bonding a heat conductor having a thermal conductivity of 10 W/m·K or higher to an electrically conductive layer. The handleability of the insulating sheet is excellent when it is uncured, and a cured product of the insulating sheet has higher adhesion, heat resistance, dielectric breakdown characteristics, and thermal conductivity. The insulating sheet used for bonding a heat conductor having a thermal conductivity of 10 W/m·K or higher to an electrically conductive layer comprises: (A) a polymer having an aromatic skeleton and a weight average molecular weight of 10,000 or more; (B) at least one of an epoxy monomer (B1) having an aromatic skeleton and a weight average molecular weight of 600 or less and an oxetane monomer (B2) having an aromatic skeleton and a weight average molecular weight of 600 or less; (C) a curing agent composed of a phenol resin, an acid anhydride having an aromatic skeleton or an alicyclic skeleton, a hydrogenated product of the acid anhydride, or a modified product of the acid anhydride; and (D) a filler. When the insulating sheet is uncured, the insulating sheet has a glass transition temperature Tg of 25° C. or lower.

### TECHNICAL FIELD

The present invention relates to an insulating sheet used for bonding a heat conductor having a thermal conductivity of 10 W/m·K or higher to an electrically conductive layer. Specifically, the present invention relates to an insulating sheet which provides excellent handleability when it is uncured, and a cured product of which has high adhesion, heat resistance, dielectric breakdown characteristics, and thermal conductivity, and a multilayer structure produced by the use of the insulating sheet.

### BACKGROUND ART

Electrical apparatuses have recently been downsized and allowed to have higher performance, and thus electronic components have been mounted with a higher package density. Such a situation makes it much important to dissipate heat generated from the electronic components. In particular, power devices used in applications such as electric vehicles are subjected to an application of a high voltage or a passage of a large current and generate a large amount of heat. Thus, it becomes more necessary to efficiently dissipate such a large amount of heat.

As a widely employed heat dissipation method, a heat conductor having high heat-dissipation capability and a thermal conductivity of 10 W/m·K or higher, such as aluminum, is bonded to a heat source. For bonding the heat conductor to the heat source, an insulating adhesive material having an insulating property is used. The insulating adhesive material is required to have a high thermal conductivity.

As one example of the insulating adhesive material, the following Patent Document 1 discloses an insulating adhesive sheet in which glass cloth is impregnated with an adhesive composition containing an epoxy resin, a curing agent for an epoxy resin, a curing accelerator, an elastomer, and an inorganic filler. Patent Document 1 mentions that the adhesive composition preferably contains 3 to 50% by weight of the inorganic filler.

Insulating adhesive materials free from glass cloth are also known. For example, the following Patent Document 2 discloses in EXAMPLES an insulating adhesive containing a bisphenol A epoxy resin, a phenoxy resin, phenol novolac, 1-cyanoethyl-2-phenylimidazole, γ-glycidoxypropyltrimethoxysilane, and alumina. Patent Document 2 discloses, as examples of the curing agent for an epoxy resin, tertiary amines, acid anhydrides, imidazole compounds, polyphenol resins, and mask-isocyanates.

The following Patent Document 3 discloses an adhesive containing 15 to 35% by weight of an inorganic powder A having an average particle size of 0.1 to 0.9 μm, 0 to 40% by weight of an inorganic powder B having an average particle size of 2.0 to 6.0 μm, and 40 to 80% by weight of an inorganic powder C having an average particle size of 10.0 to 30.0 μm. This adhesive has a relatively high thermal conductivity. Further, the adhesive has high heat-dissipation capability as it contains the aforementioned specific inorganic powders having an excellent electric insulating property in specific amounts.

The following Patent Document 4 discloses an insulating adhesive sheet containing an epoxy group-containing acryl rubber having a weight average molecular weight of 100,000 or more, an epoxy resin, a curing agent for an epoxy resin, a curing accelerator, a polymeric resin having a compatibility with the epoxy resin and a weight average molecular weight of 30,000 or more, and an inorganic filler. The insulating adhesive sheet has a minimum viscosity of 100 to 2,000 Pa·s measured with a capillary rheometer at heat adhesion temperatures.

Patent Document 1: JP 2006-342238 A

Patent Document 2: JP H08-332696 A

Patent Document 3: JP 2520988 B

Patent Document 4: JP 3498537 B

### DISCLOSURE OF THE INVENTION

The insulating adhesive sheet of Patent Document 1 is formed by the use of glass cloth for higher handleability. In the case of using glass cloth, it is difficult to make an insulating adhesive sheet thin, and it is also difficult to perform various processing such as laser processing, punching, and drill piercing on the insulating adhesive sheet. Further, a cured product of a glass cloth-containing insulating adhesive sheet has a relatively low thermal conductivity. Thus, it has insufficient heat dissipation capability in some cases. In addition, impregnation of the glass cloth with the adhesive composition requires special equipment.

The insulating adhesive of Patent Document 2 is formed without glass cloth, so that it does not have the aforementioned problems. However, this insulating adhesive itself does not have self supportability when it is uncured. Thus, the handleability of the insulating adhesive is poor.

With respect to the adhesive of Patent Document 3, a cured product of the adhesive has a low thermal conductivity and has poor adhesion due to local agglomeration of filler in some cases. Further, the cured product of the adhesive has a poor insulating property in some cases.

A cured product of the insulating adhesive sheet disclosed in Patent Document 4 has a relatively low thermal conductivity. Thus, it has insufficient heat dissipation capability in some cases.

An object of the present invention is to provide an insulating sheet which is used for bonding a heat conductor having a thermal conductivity of 10 W/m·K or higher to an electrically conductive layer, which provides excellent handleability when it is uncured, and a cured product of which has higher adhesion, heat resistance, dielectric breakdown characteristics, and thermal conductivity. Another object of the present invention is to provide a multilayer structure formed by the use of the insulating sheet.

The present invention provides an insulating sheet used for bonding a heat conductor having a thermal conductivity of 10 W/m·K or higher to an electrically conductive layer, comprising: (A) a polymer having an aromatic skeleton and a weight average molecular weight of 10,000 or more; (B) at least one of an epoxy monomer (B1) having an aromatic skeleton and a weight average molecular weight of 600 or less and an oxetane monomer (B2) having an aromatic skeleton and a weight average molecular weight of 600 or less; (C) a curing agent composed of a phenol resin, an acid anhydride having an aromatic skeleton or an alicyclic skeleton, a hydrogenated product of the acid anhydride, or a modified product of the acid anhydride; and (D) a filler. The insulating sheet contains 20 to 60% by weight of the polymer (A) and 10 to 60% by weight of the monomer (B) in 100% by weight of all resin components including the polymer (A), the monomer (B), and the curing agent (C) so that the total amount of the polymer (A) and the monomer (B) is less than 100% by weight. When the insulating sheet is uncured, the insulating sheet has a glass transition temperature Tg of 25° C. or lower, and after the insulating sheet is cured, a cured product of the insulating sheet has a dielectric breakdown voltage of 30 kW/mm or higher.

The polymer (A) is preferably a phenoxy resin. A phenoxy resin allows the cured product of the insulating sheet to have much higher heat resistance. Further, the phenoxy resin preferably has a glass transition temperature Tg of 95° C. or higher. In this case, the resin is much more prevented from heat degradation.

The curing agent (C) is a first acid anhydride having a polyalicyclic skeleton, a hydrogenated product of the first acid anhydride, or a modified product of the first acid anhydride, or a second acid anhydride having an alicyclic skeleton formed by addition reaction between a terpene compound and maleic anhydride, a hydrogenated product of either of the acid anhydride, or a modified product of either of the acid anhydride. Further, the curing agent (C) is preferably an acid anhydride represented by any one of the following formulas (1) to (3). These preferable curing agents (C) allow the insulating sheet to have much higher flexibility, moisture resistance, or adhesion.

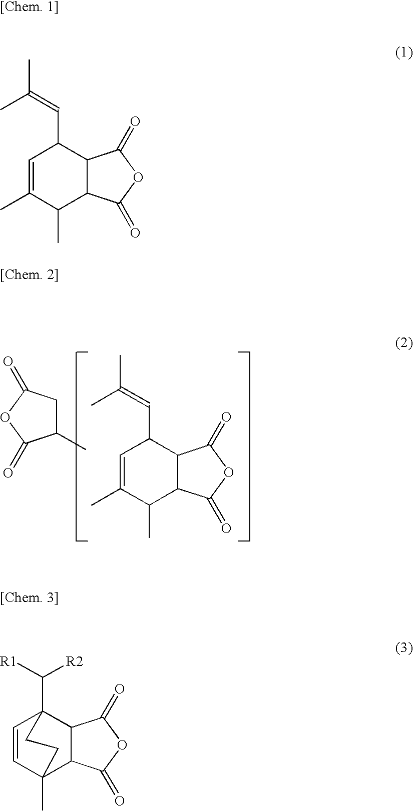

In the formula (3), R1 and R2 each represent hydrogen, a C1-C5 alkyl group, or a hydroxy group.

The curing agent (C) is preferably a phenol resin having a melamine skeleton or a triazine skeleton, or a phenol resin having an allyl group. This preferable curing agent (C) allows the cured product of the insulating sheet to have much higher flexibility and flame retardancy.

In a specific aspect of the insulating sheet according to the present invention, the filler (D) contains: a spherical filler (D1) having an average particle size of 0.1 to 0.5 μm; a spherical filler (D2) having an average particle size of 2 to 6 μm; and a spherical filler (D3) having an average particle size of 10 to 40 μm. The filler (D) contains 5 to 30% by volume of the spherical filler (D1), 20 to 60% by volume of the spherical filler (D2), and 20 to 60% by volume of the spherical filler (D3) in 100% by volume of the filler (D) so that the total amount of the spherical filler (D1), the spherical filler (D2), and the spherical filler (D3) is not more than 100% by volume.

In another specific aspect of the insulating sheet according to the present invention, the filler (D) is a crushed filler (D4) having an average particle size of 12 μM or smaller.

The filler (D) is preferably at least one selected from the group consisting of alumina, boron nitride, aluminum nitride, silicon nitride, silicon carbide, zinc oxide, and magnesium oxide. This filler (D) allows the cured product of the insulating sheet to have much higher heat dissipation capability.

In another specific aspect of the insulating sheet according to the present invention, the insulating sheet further contains a dispersing agent (F) having a functional group containing a hydrogen atom capable of forming a hydrogen bond. This dispersing agent (F) allows the cured product of the insulating sheet to have a much higher thermal conductivity and dielectric breakdown characteristics.

In another specific aspect of the insulating sheet according to the present invention, the insulating sheet further contains granular rubber (E). The granular rubber (E) allows the cured product of the insulating sheet to have much higher flexibility and stress relaxation property. The granular rubber (E) may be preferably a granular silicone rubber. The granular silicone rubber allows the cured product of the insulating sheet to have a much higher stress relaxation property.

In another specific aspect of the insulating sheet according to the present invention, the polymer (A) contains 30 to 80% by weight of the aromatic skeleton in 100% by weight of the whole polymer skeleton.

The polymer (A) preferably contains a polycyclic aromatic skeleton in the main chain. In this case, the cured product of the insulating sheet is allowed to have much higher heat resistance.

The insulating sheet of the present invention is preferably free from glass cloth. The insulating sheet according to the present invention provides excellent handleability when it is uncured even without glass cloth.

In another specific aspect of the insulating sheet according to the present invention, the insulating sheet has a bending modulus at 25° C. of 10 to 1,000 MPa when it is uncured. After the insulating sheet is cured, a cured product of the insulating sheet has a bending modulus at 25° C. of 100 to 50,000 MPa. The insulating sheet has a tan δ of 0.1 to 1.0 at 25° C. when it is uncured. When the uncured insulating sheet is heated from 25° C. to 250° C., the insulating sheet has a maximum tan δ of 1.0 to 5.0. Each of the tan δ is measured with a rotating dynamic viscoelasticity measuring apparatus.

In another specific aspect of the insulating sheet according to the present invention, the insulating sheet has a reaction ratio of 10% or lower.

A multilayer structure according to the present invention comprises: a heat conductor having a thermal conductivity of 10 W/m·K or higher; an insulating layer laminated on at least one side of the heat conductor; and an electrically conductive layer laminated on the insulating layer on the other side of the insulating layer. The insulating layer is formed by curing the insulating sheet according to the present invention.

In the multilayer structure of the present invention, the heat conductor is preferably made of metal.

### EFFECTS OF THE INVENTION

The insulating sheet according to the present invention contains the polymer (A), the monomer (B), the curing agent (C), and the filler (D) in the aforementioned specific amounts; has a glass transition temperature Tg of 25° C. or lower when it is uncured; and the cured product of the insulating sheet has a dielectric breakdown voltage of 30 kV/mm or higher. Thus, the handleability of the uncured insulating sheet is at a high level, and the cured product of the insulating sheet is allowed to have adhesion, heat resistance, dielectric breakdown characteristics, and a thermal conductivity each at a high level. Further, as the cured product of the insulating sheet has a dielectric breakdown voltage of 30 kV/mm or higher, the insulating sheet is allowed to be suitably used in large-current applications such as power devices, vehicle-mounted LEDs, and high-energy LEDs.

The multilayer structure according to the present invention includes the electrically conductive layer laminated on at least one side of the heat conductor having a thermal conductivity of 10 W/m·K or higher via the insulating layer. The insulating layer is formed by curing the insulating sheet according to the present invention, so that heat from the side of the electrically conductive layer is likely to be transmitted to the heat conductor through the insulating layer. Thus, the heat is efficiently dissipated through the heat conductor.

### BRIEF DESCRIPTION OF THE DRAWING

FIG. 1 is a partially-cutout cross-sectional front view schematically showing a multilayer structure according to one embodiment of the present invention.

### EXPLANATION OF SYMBOLS

1: Multilayer structure
2: Electrically conductive layer
2a: Surface
3: Insulating layer
4: Heat conductor

### BEST MODE FOR CARRYING OUT THE INVENTION

The following will describe the present invention in detail.

The present inventors have found that, in the case where the insulating sheet includes: (A) a polymer having an aromatic skeleton and a weight average molecular weight of 10,000 or more; (B) at least one of an epoxy monomer (B1) having an aromatic skeleton and a weight average molecular weight of 600 or less and an oxetane monomer (B2) having an aromatic skeleton and a weight average molecular weight of 600 or less; (C) a curing agent composed of a phenol resin, an acid anhydride having an aromatic skeleton or an alicyclic skeleton, a hydrogenated product of the acid anhydride, or a modified product of the acid anhydride; and (D) a filler in specific amounts, the insulating sheet has a glass transition temperature Tg of 25° C. or lower when the insulating sheet is uncured, and, after the insulating sheet is cured, a cured product of the insulating sheet has a dielectric breakdown voltage of 30 kV/mm or higher, the handleability of the uncured insulating sheet is allowed to be high, and the cured product of the insulating sheet is allowed to have higher adhesion, heat resistance, dielectric breakdown characteristics, and thermal conductivity.

The insulating sheet according to the present invention contains: (A) a polymer having an aromatic skeleton and a weight average molecular weight of 10,000 or more; (B) at least one of an epoxy monomer (B1) having an aromatic skeleton and a weight average molecular weight of 600 or less and an oxetane monomer (B2) having an aromatic skeleton and a weight average molecular weight of 600 or less; (C) a curing agent composed of a phenol resin, an acid anhydride having an aromatic skeleton or an alicyclic skeleton, a hydrogenated product of the acid anhydride, or a modified product of the acid anhydride; and (D) a filler.

### (Polymer (A)

The polymer (A) contained in the insulating sheet according to the present invention is not particularly limited as long as it has an aromatic skeleton and a weight average molecular weight of 10,000 or more. The polymer (A) may be used alone, or two or more of polymers (A) may be used in combination.

The polymer (A) may contain an aromatic skeleton at any moiety of the whole polymer, and may contain an aromatic skeleton in the main chain skeleton or in the side chain. The polymer (A) preferably contains an aromatic skeleton in the main chain skeleton. In this case, the cured product of the insulating sheet is allowed to have much higher heat resistance. The polymer (A) preferably contains a polycyclic aromatic skeleton in the main chain. In this case, the cured product of the insulating sheet is allowed to have much higher heat resistance.

The aforementioned aromatic skeleton is not particularly limited. Specific examples of the aromatic skeleton include a naphthalene skeleton, a fluorene skeleton, a biphenyl skeleton, an anthracene skeleton, a pyrene skeleton, a xanthene skeleton, an adamantane skeleton, and a bisphenol A skeleton. In particular, a biphenyl skeleton or a fluorene skeleton is preferable. In this case, the cured product of the insulating sheet is allowed to have much higher heat resistance.

The polymer (A) may be a thermoplastic resin or a thermosetting resin.

The thermoplastic resin and the thermosetting resin are not particularly limited. Examples of the thermoplastic resin and the thermosetting resin include thermoplastic resins such as polyphenylene sulfide, polysulfone, polyethersulfone, polyetheretherketone, and polyetherketone. In addition, the examples of the thermoplastic resin and the thermosetting resin further include heat-resistant resins, which are so-called super engineering plastics, such as thermoplastic polyimide, thermosetting polyimide, benzoxazine, and a reaction product of polybenzoxazole and benzoxazine. Each of the thermoplastic resins may be used alone, or two or more of these may be used in combination. Also, each of the thermosetting resins may be used alone, or two or more of these may be used in combination. Either one of a thermoplastic resin or a thermosetting resin may be used, or both of a thermoplastic resin and a thermosetting resin may be used in combination.

The polymer (A) is preferably a styrenic polymer or a phenoxy resin, and more preferably a phenoxy resin. In this case, the cured product of the insulating sheet is allowed to have resistance against oxidation aging and much higher heat resistance.

Specific examples of the styrenic polymer include polymers containing only styrenic monomers or copolymers containing styrenic monomers and acrylic monomers. Particularly preferable are styrenic polymers having a styrene-glycidyl methacrylate structure.

Examples of the styrenic monomer include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene. Each of the styrenic monomers may be used alone, or two or more of these may be used in combination.

Examples of the acrylic monomer include acrylic acid, methacrylic acid, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, glycidyl methacrylate, ethyl β-hydroxy acrylate, propyl γ-amino acrylate, stearyl methacrylate, dimethylaminoethyl methacrylate, and diethylaminoethyl methacrylate. Each of the acrylic monomers may be used alone, or two or more of these may be used in combination.

Specifically, the phenoxy resin is a resin formed by the reaction between epihalohydrin and a dihydric phenol compound or a resin formed by the reaction between a dihydric epoxy compound and a dihydric phenol compound.

The phenoxy resin preferably has at least one skeleton selected from the group consisting of a bisphenol A skeleton, a bisphenol F skeleton, a bisphenol A/F mixed skeleton, a naphthalene skeleton, a fluorene skeleton, a biphenyl skeleton, an anthracene skeleton, a pyrene skeleton, a xanthene skeleton, an adamantane skeleton, and a dicyclopentadiene skeleton. In particular, the phenoxy resin more preferably has at least one skeleton selected from the group consisting of a bisphenol A skeleton, a bisphenol F skeleton, a bisphenol A/F mixed skeleton, a naphthalene skeleton, a fluorene skeleton, and a biphenyl skeleton. The phenoxy resin further preferably has at least one of a fluorene skeleton and a biphenyl skeleton. In the case where the phenoxy resin has such preferable skeletons, the cured product of the insulating sheet is allowed to have much higher heat resistance.

The phenoxy resin preferably has a polycyclic aromatic skeleton in the main chain. The phenoxy resin more preferably has at least one of the skeletons represented by the formulas (4) to (9) in the main chain.

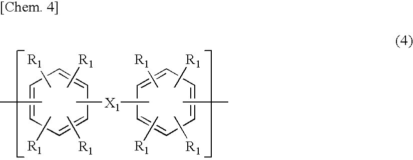

In the formula (4), R₁s each may be the same as or different from each other, and are a hydrogen atom, a C1-C10 hydrocarbon group, or a halogen atom; and X₁ is a single bond, a C1-C7 dihydric hydrocarbon group, —O—, —S—, —SO₂—, or —CO—.

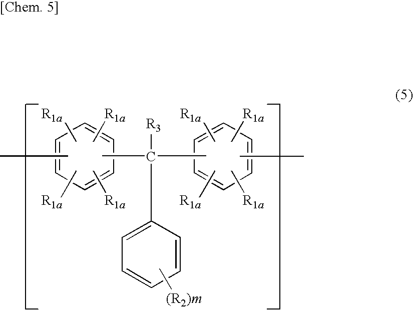

In the formula (5), R₁ₐs each may be the same as or different from each other, and are a hydrogen atom, a C1-C10 hydrocarbon group, or a halogen atom; R₂ is a hydrogen atom, a C1-C10 hydrocarbon group, or a halogen atom; R₃ is a hydrogen atom or a C1-C10 hydrocarbon group; and m is an integer of 0 to 5.

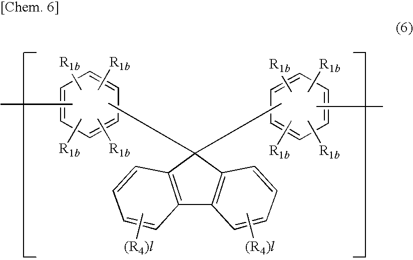

In the formula (6), R_{1b}s each may be the same as or different from each other, and are a hydrogen atom, a C1-C10 hydrocarbon group, or a halogen atom; R₄s each may be the same as or different from each other, and are a hydrogen atom, a C1-C10 hydrocarbon group, or a halogen atom; and l is an integer of 0 to 4.

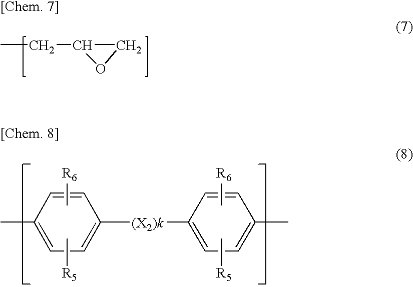

In the formula (8), R₅s and R6s each is a hydrogen atom, a C1-C5 alkyl group, or a halogen atom; X₂ is —SO₂—, —CH₂—, —C(CH₃)₂—, or —O—; and k is 0 or 1.

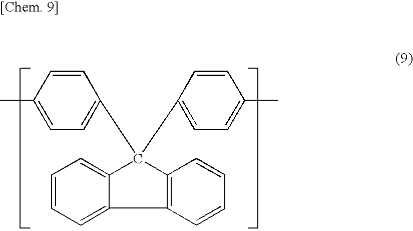

For example, a phenoxy resin represented by the following formula (10) or (11) may be suitably used as the aforementioned polymer (A).

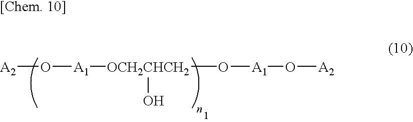

In the formula (10), A₁ has the structures represented by any of the formulas (4) to (6), and the structure of the formula (4) occupies 0 to 60 mol %, the structure of the formula (5) occupies 5 to 95 mol %, and the structure of the formula (6) occupies 5 to 95 mol %; A₂ is a hydrogen atom or a group represented by the formula (7); and n₁ is 25 to 500 on average.

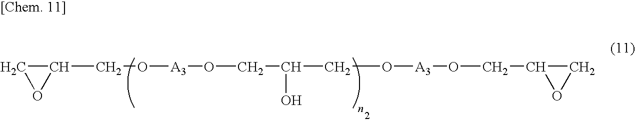

In the formula (II), A₃ has the structure represented by the formula (8) or (9); and n₂ is not less than 21.

The polymer (A) has a glass transition temperature Tg of preferably 60° C. to 200° C., and more preferably 90° C. to 180° C. A too low Tg of the polymer (A) may cause heat aging of the resin. A too high Tg of the polymer (A) may cause poor compatibility of the polymer (A) with other resins. In the result, the handleability of the uncured insulating sheet may be poor, and the cured product of the insulating sheet may have poor heat resistance.

In the case where the polymer (A) is a phenoxy resin, the phenoxy resin has a glass transition temperature Tg of preferably 95° C. or higher, and more preferably 100° C. or higher. The glass transition temperature of the phenoxy resin is further preferably in the range of 110° C. to 200° C., and particularly preferably in the range of 110° C. to 180° C. A too low Tg of the phenoxy resin may cause heat aging of the resin. A too high Tg of the phenoxy resin may cause poor compatibility of the phenoxy resin with other resins. In the result, the handleability of the insulating sheet may be poor, and the cured product of the insulating sheet may have poor heat resistance.

The polymer (A) has a weight average molecular weight of 10,000 or more. The weight average molecular weight of the polymer (A) is preferably 30,000 or more. The weight average molecular weight of the polymer (A) is more preferably in the range of 30,000 to 1,000,000, and further preferably in the range of 40,000 to 250,000. A too low weight average molecular weight of the polymer (A) may cause heat aging of the insulating sheet. A too high weight average molecular weight of the polymer (A) may cause poor compatibility of the polymer (A) with other resins. In the result, the handleability of the insulating sheet may be poor and the cured product of the insulating sheet may have poor heat resistance.

The polymer (A) preferably contains 30 to 80% by weight of an aromatic skeleton in 100% by weight of the whole skeleton. In this case, the insulating sheet is allowed to have self supportability owing to the electron interaction between the aromatic skeletons even when the insulating sheet is uncured. Thus, the handleability of the uncured insulating sheet may be remarkably higher. The aromatic skeleton in an amount of less than 30% by weight may cause poor handleability of the uncured insulating sheet. As the amount of the aromatic skeleton increases, the handleability of the uncured insulating sheet tends to increase; however, the aromatic skeleton in an amount of more than 80% may cause the insulating sheet to be hard and brittle. The polymer (A) more preferably contains 40 to 80% by weight of the aromatic skeleton, and further preferably contains 50 to 70% by weight of the aromatic skeleton, in 100% by weight of the whole skeleton.

The insulating sheet contains 20 to 60% by weight of the polymer (A) in 100% by weight of all the resin components including the polymer (A), the monomer (B), and the curing agent (C). The insulating sheet preferably contains 30 to 50% by weight of the polymer (A) in 100% by weight of all the resin components. Preferably, the amount of the polymer (A) is in the aforementioned range, and the total amount of the polymer (A) and the monomer (B) is less than 100% by weight. A too small amount of the polymer (A) may cause poor handleability of the uncured insulating sheet. A too large amount of the polymer (A) may cause difficulty in dispersing the filler (D). Here, “all the resin components” include the polymer (A), the epoxy monomer (B1), the oxetane monomer (B2), the curing agent (C), and the other resin components added if necessary.

### (Monomer (B))

The insulating sheet according to the present invention contains at least one monomer (B) of an epoxy polymer (B1) having an aromatic skeleton and a weight average molecular weight of 600 or less and an oxetane monomer (B2) having an aromatic skeleton and a weight average molecular weight of 600 or less. The insulating sheet may contain, as the monomer (B), only the epoxy monomer (B1), only the oxetane monomer (B2), or both of the epoxy monomer (B1) and the oxetane monomer (B2).

The epoxy monomer (B1) is not particularly limited as long as it has an aromatic skeleton and a weight average molecular weight of 600 or less. Specific examples of the epoxy monomer (B1) include an epoxy monomer having a bisphenol skeleton, an epoxy monomer having a dicyclopentadiene skeleton, an epoxy monomer having a naphthalene skeleton, an epoxy monomer having an adamantane skeleton, an epoxy monomer having a fluorene skeleton, an epoxy monomer having a biphenyl skeleton, an epoxy monomer having a bi(glycidyloxyphenyl) methane skeleton, an epoxy monomer having a xanthene skeleton, an epoxy monomer having an anthracene skeleton, and an epoxy monomer having a pyrene skeleton. Each of these epoxy monomers (B1) may be used alone, or two or more of these may be used in combination.

Examples of the epoxy monomer having a bisphenol skeleton include an epoxy monomer having a bisphenol skeleton including a bisphenol A skeleton, a bisphenol F skeleton, or a bisphenol S skeleton.

Examples of the epoxy monomer having a dicyclopentadiene skeleton include a phenol novolac epoxy monomer having a dicyclopentadiene dioxide skeleton or a dicyclopentadiene skeleton.

Examples of the epoxy monomer having a naphthalene monomer include 1-glycidyl naphthalene, 2-glycidyl naphthalene, 1,2-diglycidyl naphthalene, 1,5-diglycidyl naphthalene, 1,6-diglycidyl naphthalene, 1,7-diglycidyl naphthalene, 2,7-diglycidyl naphthalene, triglycidyl naphthalene, and 1,2,5,6-tetraglycidyl naphthalene.

Examples of the epoxy monomer having an adamantane skeleton include 1,3-bis(4-glycidyloxyphenyl)adamantane and 2,2-bis(4-glycidyloxyphenyl)adamantane.

Examples of the epoxy monomer having a fluorene skeleton include 9,9-bis(4-glycidyloxyphenyl)fluorene, 9,9-bis(4-glycidyloxy-3-methylphenyl)fluorene, 9,9-bis(4-glycidyloxy-3-chlorophenyl)fluorene, 9,9-bis(4-glycidyloxy-3-bromophenyl)fluorene, 9,9-bis(4-glycidyloxy-3-fluorophenyl)fluorene, 9,9-bis(4-glycidyloxy-3-methoxyphenyl)fluorene, 9,9-bis(4-glycidyloxy-3,5-dimethylphenyl)fluorene, 9,9-bis(4-glycidyloxy-3,5-dichlorophenyl)fluorene, and 9,9-bis(4-glycidyloxy-3,5-dibromophenyl)fluorene.

Examples of the epoxy monomer having a biphenyl skeleton include 4,4′-diglycidylbiphenyl and 4,4′-diglycidyl-3,3′,5,5′-tetramethylbiphenyl.

Examples of the epoxy monomer having a bi(glycidyloxyphenyl)methane skeleton include 1,1′-bi(2,7-glycidyloxynaphthyl)methane, 1,8′-bi(2,7-glycidyloxynaphthyl)methane, 1,1′-bi(3,7-glycidyloxynaphthyl)methane, 1,8′-bi(3,7-glycidyloxynaphthyl)methane, 1,1′-bi(3,5-glycidyloxynaphthyl)methane, 1,8′-bi(3,5-glycidyloxynaphthyl)methane, 1,2′-bi(2,7-glycidyloxynaphthyl)methane, 1,2′-bi(3,7-glycidyloxynaphthyl)methane, and 1,2′-bi(3,5-glycidyloxynaphthyl)methane.

Examples of the epoxy monomer having a xanthene skeleton include 1,3,4,5,6,8-hexamethyl-2,7-bis-oxiranylmethoxy-9-phenyl-9H-xanthene.

The oxetane monomer (B2) is not particularly limited as long as it has an aromatic skeleton and a weight average molecular weight of 600 or less. Specific examples of the oxetane monomer (B2) include 4,4′-bis[(3-ethyl-3-oxetanyl)methoxymethyl]biphenyl, 1,4-benzenedicarboxylic acid bis[(3-ethyl-3-oxetanyl)methyl]ester, 1,4-bis[(3-ethyl-3-oxetanyl)methoxymethyl]benzene, and oxetane-modified phenol novolac. Each of these oxetane monomers (B2) may be used alone, or two or more of these may be used in combination.

The weight average molecular weight of the epoxy monomer (B1) and the oxetane monomer (B2), that is, the weight average molecular weight of the monomer (B) is 600 or less. The preferable lower limit of the weight average molecular weight of the monomer (B) is 200, and the preferable upper limit thereof is 550. The monomer (B) having a too low weight average molecular weight may cause too high volatility of the monomer (B), resulting in poor handleability of the insulating sheet. The monomer (B) having a too high weight average molecular weight may make the insulating sheet hard and brittle, and may cause the cured product of the insulating sheet to have poor adhesion.

The insulating sheet contains 10 to 60% by weight of the monomer (B) in 100% by weight of all the resin components including the polymer (A), the monomer (B), and the curing agent (C). The insulating sheet preferably contains 10 to 40% by weight of the monomer (B) in 100% by weight of all the resin components. The amount of the monomer (B) is preferably in the above range while the total amount of the polymer (A) and the monomer (B) is less than 100% by weight. A too small amount of the monomer (B) may cause the cured product of the insulating sheet to have poor adhesion and heat resistance. A too large amount of the monomer (B) may cause the insulating sheet to have poor flexibility.

(Curing agent (C))

The curing agent (C) is a phenol resin, an acid anhydride having an aromatic skeleton or an alicyclic skeleton, a hydrogenated product of the acid anhydride, or a modified product of the acid anhydride. This curing agent (C) provides the cured product of the insulating sheet having an excellent balance among heat resistance, moisture resistance, and electric properties. The curing agent (C) may be used alone, or two or more of the curing agents (C) may be used in combination.

The phenol resin is not particularly limited. Specific examples of the phenol resin include phenol novolac, o-cresol novolac, p-cresol novolac, t-butyl phenol novolac, dicyclopentadiene cresol, polyparavinyl phenol, bisphenol A novolac, xylylene-modified novolac, decalin-modified novolac, poly(di-o-hydroxyphenyl)methane, poly(di-m-hydroxyphenyl)methane, and poly(di-p-hydroxyphenyl)methane. In particular, a phenol resin having a melamine skeleton, a phenol resin having a triazine skeleton, or a phenol resin having an allyl group is preferable as these phenol resins allow the insulating sheet to have much higher flexibility and the cured product of the insulating sheet to have much higher flame retardancy.

Commercially available products of the phenol resin include MEH-8005, MEH-8010, and NEH-8015 (produced by Meiwa Plastic Industries, Ltd.); YLH903 (produced by Japan Epoxy Resins Co., Ltd.); LA-7052, LA-7054, LA-7751, LA-1356, and LA-3018-50P (produced by Dainippon Ink and Chemicals, Corp.); and PS6313 and PS6492 (produced by Gunei Chemical Industry Co., Ltd.).

The acid anhydride having an aromatic skeleton, the hydrogenated product of the acid anhydride, or the modified product of the acid anhydride is not particularly limited. Examples of the acid anhydride having an aromatic skeleton, the hydrogenated product of the acid anhydride, or the modified product of the acid anhydride include copolymers of styrene and maleic anhydride, benzophenone tetracarboxylic anhydrides, pyromellitic anhydride, trimellitic anhydride, 4,4′-oxydiphthalic anhydride, phenylethynylphthalic anhydride, glycerol bis(anhydrotrimellitate)monoacetate, ethyleneglycol bis(anhydrotrimellitate), methyltetrahydrophthalic anhydride, methylhexahydrophthalic anhydride, and trialkyltetrahydrophthalic anhydrides. In particular, methyl nadic anhydride or a trialkyltetrahydrophthalic anhydride is preferable. Methyl nadic anhydride and a trialkyltetrahydrophthalic anhydride allow the cured product of the insulating sheet to have higher water resistance.

Commercially available products of the acid anhydride having an aromatic skeleton, the hydrogenated product of the acid anhydride, or the modified product of the acid anhydride include SMA resin EF30, SMA resin EF40, SMA resin EF60, and SMA resin EF80 (produced by Sartomer Japan Inc.); ODPA-M and PEPA (produced by MANAC Inc.); RIKACID MTA-10, RIKACID MTA-15, RIKACID TMTA, RIKACID TMEG-100, RIKACID TMEG-200, RIKACID TMEG-300, RIKACID TMEG-500, RIKACID TMEG-S, RIKACID TH, RIKACID HT-1A, RIKACID HH, RIKACID MH-700, RIKACID MT-500, RIKACID DSDA, and RIKACID TDA-100 (produced by New Japan Chemical Co., Ltd.); and EPICLON B4400, EPICLON B650, and EPICLON B570 (produced by Dainippon Ink and Chemicals, Corp.).

Further, the acid anhydride having an alicyclic skeleton, the hydrogenated product of the acid anhydride, or the modified product of the acid anhydride is preferably a first acid anhydride having a polyalicyclic skeleton, a second acid anhydride formed by addition reaction of a terpene compound and maleic anhydride, a hydrogenated product of either of the acid anhydrides, or a modified product of either of the acid anhydrides. In this case, the insulating sheet is allowed to have much higher flexibility, moisture resistance, or adhesion. In addition, the acid anhydride having an alicyclic skeleton, the hydrogenated product of the acid anhydride, or the modified product of the acid anhydride may be a methyl nadic anhydride, an acid anhydride having a dicyclopentadiene skeleton, or a modified product of either of the acid anhydrides.

Commercially available products of the first acid anhydride having an alicyclic skeleton, the hydrogenated product of the first acid anhydride, or the modified product of the first acid anhydride include RIKACID HNA and RIKACID HNA-100 (produced by New Japan Chemical Co., Ltd.); and EPIKURE YH306, EPIKURE YH307, EPIKURE YH308H, and EPIKURE YH309 (produced by Japan Epoxy Resins Co., Ltd.).

The curing agent (C) is preferably an acid anhydride represented by any of the following formulas (1) to (3). This preferable curing agent (C) allows the insulating sheet to have much higher flexibility, moisture resistance, or adhesion.

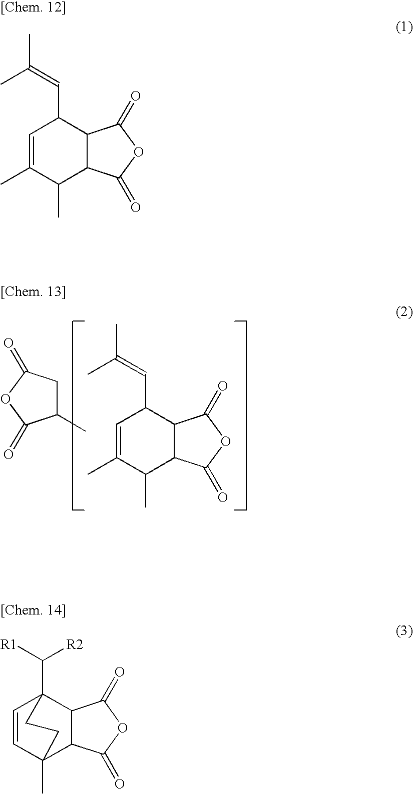

In the formula (3), R1 and R2 each are hydrogen, a C1-C5 alkyl group, or a hydroxy group.

In addition to the curing agent, a curing accelerator may be contained in the insulating sheet for adjusting a curing rate and physical properties of the cured product.

The curing accelerator is not particularly limited. Specific examples of the curing accelerator include tertiary amines, imidazoles, imidazolines, triazines, organophosphorus compounds, quaternary phosphonium salts, and diazabicycloalkenes such as organic acid salts. Examples of the curing accelerator further include organic metal compounds, quaternary ammonium salts, and halogenated metals. Examples of the organic metal compound include zinc octylate, tin octylate, and aluminum-acetyl-acetone complexes.

Examples of the curing accelerator include imidazole curing accelerators with a high melting point, dispersible latent curing accelerators with a high melting point, micro-capsulated latent curing accelerators, amine salt latent curing accelerators, and high-temperature dissociative and thermal cation polymerizable latent curing accelerators. Each of these curing accelerators may be used alone, or two or more of these may be used in combination.

Examples of the dispersible latent accelerator with a high melting point include amine-addition accelerators in which dicyanamide or amine is added to an epoxy monomer. Examples of the micro-capsulated latent accelerator include micro-capsulated latent accelerators formed by covering the surface of an accelerator such as an imidazole accelerator, a phosphorus accelerator, or a phosphine accelerator with a polymer. Examples of the high-temperature dissociative and thermal cation polymerizable latent curing accelerator include Lewis acid salts and Bronsted acid salts.

The curing accelerator is preferably an imidazole curing accelerator with a high melting point. The imidazole curing accelerator with a high melting point enables easy control of the reaction system and much easier adjustment of the curing rate of the insulating sheet and the physical properties of the cured product of the insulating sheet. A curing accelerator with a high melting point of 100° C. or higher may be excellently easy to handle. Thus, the curing accelerator preferably has a melting point of 100° C. or higher.

The insulating sheet contains preferably 10 to 40% by weight, and more preferably 12 to 25% by weight, of the curing agent (C) in 100% by weight of all the resin components including the polymer (A), the monomer (B), and the curing agent (C). A too small amount of the curing agent (C) may cause difficulty in sufficiently curing the insulating sheet. A too large amount of the curing agent (C) may cause an excessive amount of the curing agent which is not involved in the curing or may cause insufficient cross-linking of the cured product. This may cause the cured product of the insulating sheet to have insufficient heat resistance and adhesion.

### (Filler (D))

The insulating sheet according to the present invention contains a filler (D). Thus, the cured product of the insulating sheet is allowed to have higher thermal conductivity. Further, the cured product of the insulating sheet is allowed to have higher heat dissipation capability. The filler (D) may be used alone, or two or more of the fillers (D) may be used in combination.

The filler (D) is not particularly limited. The filler (D) preferably has a thermal conductivity of 30 W/m·K or higher. Examples of the filler (D) having a thermal conductivity of 30 W/m·K or higher include alumina, boron nitride, aluminum nitride, silicon nitride, silicon carbide, zinc oxide, and magnesium oxide.

The filler (D) is preferably at least one selected from the group consisting of alumina, boron nitride, aluminum nitride, silicon nitride, silicon carbide, zinc oxide, and magnesium oxide. In this case, the cured product of the insulating sheet is allowed to have much higher heat dissipation capability. Further, the filler (D) is preferably at least one selected from the group consisting of alumina, boron nitride, aluminum nitride, silicon nitride, silicon carbide, and magnesium oxide.

The filler (D) is preferably at least one selected from the group consisting of alumina, boron nitride, aluminum nitride, silicon nitride, and silicon carbide. In this case, use of a dispersing agent having a low pKa value, that is, having a high acidity, as the below-mentioned dispersing agent (F) may prevent the filler (D) from dissolving in the dispersing agent (F).

The filler (D) is preferably at least one of spherical alumina and spherical aluminum nitride. The filler (D) may be filled into the insulating sheet at a high density when it is at least one of spherical alumina and spherical aluminum nitride, so that the cured product of the insulating sheet is allowed to have much higher heat dissipation capability.

The filler (D) preferably has an average particle size of 0.1 to 40 μm. A filler (D) having an average particle size of smaller than 0.1 μm may cause difficulty in filling the filler (D) into the insulating sheet at a high density. A filler (D) having an average particle size of 40 μm or greater may cause the cured product of the insulating sheet to have poor dielectric breakdown characteristics.

The term “average particle size” herein represents an average particle size determined from the result of particle size distribution measurement in terms of volume average measured with a laser diffractive particle size distribution measuring apparatus.

The insulating sheet contains preferably 40 to 90% by volume, and more preferably 50 to 90% by volume, of the filler (D) in 100% by volume of the insulating sheet. The preferable lower limit of the amount of the filler (D) is 65% by volume, and the preferable upper limit thereof is 85% by volume. A too small amount of the filler (D) may cause the cured product of the insulating sheet to have insufficient heat dissipation capability. A too large amount of the filler (D) may cause the insulating sheet to have remarkably poor flexibility and adhesion.

The filler (D) preferably contains a spherical filler (D1) having an average particle size of 0.1 to 0.5 μm, a spherical filler (D2) having an average particle size of 2 to 6 μm, and a spherical filler (D3) having an average particle size of 10 to 40 μm. In this case, the filler (D) preferably contains 5 to 30% by volume of the spherical filler (D1), 20 to 60% by volume of the spherical filler (D2), and 20 to 60% by volume of the spherical filler (D3) in 100% by volume of the filler (D) so that the total amount of the spherical filler (D1), the spherical filler (D2), and the spherical filler (D3) is not more than 100% by volume.

In the case where the filler (D) contains the spherical filler (D1) having a small particle size, the spherical filler (D2) having a medium particle size, and the spherical filler (D3) having a large particle size in the aforementioned amounts, the cured product of the insulating sheet is allowed to have a much higher thermal conductivity, adhesion, and dielectric breakdown characteristics.

A spherical filler (D1) having an average particle size of smaller than 0.1 μm may cause difficulty in filling the filler (D) and may cause the cured product of the insulating sheet to have poor adhesion.

If the spherical filler (D1) has an average particle size of greater than 0.5 μm or the spherical filler (D2) has an average particle size of smaller than 2 μm, the particle sizes of the spherical filler (D1) and the spherical filler (D2) are too close to each other. This may cause difficulty in forming a close-packed structure and cause insufficient filling of the filler (D). Thus, the cured product of the insulating sheet may have poor thermal conductivity. Further, the filler (D) may locally agglomerate to cause the cured product of the insulating sheet to have a poor adhesion and insulating property.

If the spherical filler (D2) has an average particle size of greater than 6 μm or the spherical filler (D3) has an average particle size of smaller than 10 μm, the particle sizes of the spherical filler (D2) and the spherical filler (D3) are too close to each other. This may cause insufficient filling of the filler (D). Thus, the cured product of the insulating sheet may have poor thermal conductivity. Further, the filler (D) may locally agglomerate to cause the cured product of the insulating sheet to have a poor adhesion and insulating property.

A filler (D3) having an average particle size of greater than 40 μm may cause the cured product of the insulating sheet to have a remarkably poor insulating property when the insulating sheet is as thin as about 100 μm.

The aforementioned adhesive in Patent Document 3 contains three inorganic powders A to C each having a different particle size. However, for example, when the inorganic powder A has an average particle size of greater than 0.5 μm and not greater than 0.9 μm, this particle size is too close to the particle size of the inorganic powder B having an average particle size of 2.0 to 6.0 μm. This may cause insufficient filling of the inorganic powders. Thus, the cured product of the insulating sheet may have a lower thermal conductivity. Further, the filler may locally agglomerate to cause the cured product of the insulating sheet to have poor adhesion and insulating property. If a too small amount of the inorganic powder B having an average particle size of 2.0 to 6.0 μm is used or a too large amount of the inorganic powder C having an average particle size of 10 to 30 μm is used, the inorganic filler may be insufficiently filled. Thus, the cured product of the insulating sheet may have a lower thermal conductivity. Further, the filler may locally agglomerate to cause the cured product of the insulating sheet to have poor adhesion and insulating property.

Further, depending on resin components other than the inorganic powders A to C contained in the adhesive disclosed in Patent Document 3, the cured product of the adhesive may have poor dielectric breakdown characteristics and adhesion.

If the filler (D) contains the spherical fillers (D1), (D2), and (D3) each in a volume ratio outside the aforementioned range, the filler (D) may be insufficiently filled. Thus, the cured product of the insulating sheet may have a lower thermal conductivity. Further, the filler (D) may agglomerate to cause the cured product of the insulating sheet to have poor adhesion and insulating property.

The spherical fillers (D1), (D2), and (D3) each have a spherical shape. The term “spherical” means that the aspect ratio is within 1 to 2.

In the case where the spherical fillers (D1), (D2), and (D3) are used, other filler having a particle size different from those of the spherical fillers (D1), (D2), and (D3) or not having a spherical shape may be further contain in the filler (D). The insulating sheet is preferably free from the other filler. If containing the other filler, the insulating sheet contains 5% by volume or less of the other filler in 100% by volume of the filler (D).

With respect to the particle size distribution of the spherical filler (D1), the maximum particle size is preferably 2 μm or smaller, and the minimum particle size is preferably 0.01 μm or greater. With respect to the particle size distribution of the spherical filler (D2), the maximum particle size is preferably 40 μm or smaller, and the minimum particle size is preferably 0.1 μm or greater. With respect to the particle size distribution of the spherical filler (D3), the maximum particle size is preferably 60 μm or smaller, and the minimum particle size is preferably 0.5 μm or greater.

In the case of measuring the particle size distribution of the whole filler (D) contained in the insulating sheet and then determining the cumulative volume of the filler (D), starting from a smaller particle size, the cumulative volume at a particle size of 0.1 μm is preferably 0 to 5%, the cumulative volume at a particle size of 0.5 μm is preferably 1 to 10%, the cumulative volume at a particle size of 2 μm is preferably 2 to 20%, the cumulative volume at a particle size of 6 μm is preferably 20 to 50%, the cumulative volume at a particle size of 10 μm is preferably 30 to 80%, and the cumulative volume at a particle size of 40 μm is preferably 80 to 100%.

The term “particle size distribution” means a volume average particle size distribution measured with a laser diffractive particle size distribution measuring apparatus.

The spherical fillers (D1), (D2), and (D3) each preferably have the same main component. In this case, variation in dispersion of the filler (D) due to difference among the specific gravities is less likely to occur.

The filler (D) is preferably a crushed filler (D4) having an average particle size of 12 μm or smaller. The crushed filler (D4) may be used alone, or two or more of these may be used in combination.

The crushed filler (D4) may be prepared by crushing a massive inorganic substance with, for example, a single-shaft crushing apparatus, a twin-shaft crushing apparatus, a hummer crushing apparatus, or a ball-milling apparatus. The crushed filler (D4) is likely to allow the filler (D) in the insulating sheet to have a bridged structure or an efficiently adjacent structure. Thus, the cured product of the insulating sheet is allowed to have much higher thermal conductivity. In addition, the crushed filler (D4) generally costs low compared to common fillers. Thus, use of the crushed filler (D4) reduces the cost of the insulating sheet.

The crushed filler (D4) preferably has an average particle size of 12 μm or smaller. A crushed filler having an average particle size of greater than 12 μm may not be dispersed at a high density in the insulating sheet, and thus the cured product of the insulating sheet may have poor dielectric breakdown characteristics. The preferable upper limit of the average particle size of the crushed filler (D4) is 10 μm and the preferable lower limit thereof is 1 μm. A crushed filler (D4) having a too small average particle size may cause difficulty in filling the crushed filler (D4) at a high density.

The aspect ratio of the crushed filler (D4) is not particularly limited. The aspect ratio of the crushed filler (D4) is preferably 1.5 to 2.0. Filler having an aspect ratio of less than 1.5 may cost relatively high. Thus, the insulating sheet costs high. Filler having an aspect ratio of higher than 20 may cause difficulty in filling the filler (D4).

The aspect ratio of the crushed filler (D4) may be determined by, for example, measuring the crushed surface of the filler with a digital image analysis particle size distribution measuring apparatus (FPA, produced by Nihon Rufuto Co., Ltd.).

The crushed filler (D4) is preferably at least one selected from the group consisting of alumina, boron nitride, aluminum nitride, silicon nitride, and silicon carbide. The use of these preferable crushed fillers (D4) allow the cured product of the insulating sheet to have much higher heat dissipation capability.

### (Dispersing Agent (F))

The insulating sheet according to the present invention preferably further contains a dispersing agent (F) having a functional group containing a hydrogen atom capable of forming a hydrogen bond. The dispersing agent (F) allows the cured product of the present invention to have much higher thermal conductivity and dielectric breakdown characteristics. The dispersing agent (F) may be used alone, or two or more of these may be used in combination.

Examples of the functional group containing a hydrogen atom capable of forming a hydrogen bond include a carboxyl group (pKa=4), a phosphoric acid group (pKa=7), and a phenol group (pKa=10).

The pKa of the functional group containing a hydrogen atom capable of forming a hydrogen bond is preferably 2 to 10, and more preferably 3 to 9. If the pKa is lower than 2, the dispersing agent (F) has a too high acidity, so that reactions of the epoxy component and the oxetane component as the resin components are likely to be accelerated. Further, the uncured insulating sheet may have poor storage stability. If the pKa is higher than 10, the dispersing agent (F) may insufficiently exert its effects, and the cured product of the insulating sheet may have insufficient thermal conductivity and dielectric breakdown characteristics.

The functional group containing a hydrogen atom capable of forming a hydrogen bond is preferably a carboxyl group or a phosphoric acid group. In this case, the cured product of the insulating sheet is allowed to have much higher thermal conductivity and dielectric breakdown characteristics.

Specific examples of the dispersing agent (F) include polyester carboxylic acids, polyether carboxylic acids, polyacrylic carboxylic acids, aliphatic carboxylic acids, polysiloxane carboxylic acids, polyester phosphoric acids, polyether phosphoric acids, polyacrylic phosphoric acids, aliphatic phosphoric acids, polysiloxane phosphoric acids, polyester phenols, polyether phenols, polyacrylic phenols, aliphatic phenols, and polysiloxane phenols.

In the case of using the crushed filler (D4), the crushed surfaces contacting one another tend to strongly agglomerate. This causes difficulty in dispersing the crushed filler (D4) at a high density in the insulating sheet in the case of using the crushed filler (D4). Thus, the handleability of the uncured insulating sheet may be poor, and the cured product of the insulating sheet may have poor dielectric breakdown characteristics and thermal conductivity. Here, use of the dispersing agent (E) with the crushed filler (D4) allows the crushed filler (D4) to be dispersed at a high density in the insulating sheet. Thus, the handleability of the uncured insulating sheet may be better, and the cured product of the insulating sheet may have higher dielectric breakdown characteristics and thermal conductivity.

The insulating sheet contains preferably 0.01 to 20% by weight, and more preferably 0.1 to 10% by weight, of the dispersing agent (F) in 100% by weight of the insulating sheet. The dispersing agent (F) in an amount within this range may prevent agglomeration of the filler (D) and allow the cured product of the insulating sheet to have much higher thermal conductivity and dielectric breakdown characteristics.

### (Granular Rubber (E))

The insulating sheet according to the present invention may contain granular rubber (E). In the case of containing the granular rubber, the cured product of the insulating sheet is allowed to have a higher stress relaxation property.

The granular rubber (E) is not particularly limited. Examples of the granular rubber (E) include acryl rubber, butadiene rubber, isoprene rubber, acrylonitrile-butadiene rubber, styrene-butadiene rubber, styrene-isoprene rubber, urethane rubber, silicone rubber, fluorine rubber, and natural rubber. The property of the granular rubber is not particularly limited.

The granular rubber (E) is preferably granular silicone rubber. In this case, the insulating sheet is allowed to have a much better stress relaxation property and the cured product of the insulating sheet is allowed to have much higher flexibility.

Combination use of the granular rubber (E) and the filler (D) allows the insulating sheet to have a low coefficient of linear thermal expansion and to have stress relaxation capability together. Thus, the cured product of the insulating sheet is less likely to suffer peeling or cracking even when exposed to high temperature conditions or temperature cycle conditions.

The insulating sheet contains preferably 0.1 to 40% by weight, and more preferably 0.3 to 20% by weight, of the granular rubber (E) in 100% by weight of the insulating sheet. A too small amount of the granular rubber (E) may cause the cured product of the insulating sheet to have an insufficient stress relaxation property. A too large amount of the granular rubber (E) may cause the cured product of the insulating sheet to have poor adhesion.

### (Other Components)

The insulating sheet according to the present invention may contain a substrate material such as glass cloth, glass bonded-fiber-fabric, or aramid bonded-fiber-fabric for much better handleability. Here, the insulating sheet according to the present invention has self supportability without containing the substrate material even when it is uncured at room temperature (23° C.), and the handleability thereof is excellent. Thus, the insulating sheet is preferably free from a substrate material, in particular, glass cloth. When being free from the substrate material, the insulating sheet may be made thin, and the cured product of the insulating sheet may have much higher thermal conductivity. Further, the insulating sheet may be easily subjected to processes such as laser processing and drilling if necessary. Here, the term “self supportability” means that the sheet is capable of retaining its shape and being handled as a sheet even without a supporting medium such as a PET film or a copper foil and even when it is uncured.

In addition, the insulating sheet according to the present invention may contain additives such as a thixotropic agent, a dispersing agent, a flame retardant, and a coloring agent.

Examples of the thixotropic agent include polyamide resin, fatty acid amide resin, polyamide resin, and dioctyl phthalate resin.

Examples of the dispersing agent include anionic dispersing agents, cationic dispersing agents, and nonionic dispersing agents.

Examples of the anionic dispersing agent include fatty acid soaps, alkyl sulfates, sodium dialkyl sulfosuccinates, and sodium alkylbenzene sulfonates. Examples of the cationic dispersing agent include decylamine acetate, trimethyl ammonium chloride, and dimethyl(benzyl)ammonium chloride. Examples of the nonionic dispersing agent include polyethylene glycol ether, polyethylene glycol ester, sorbitan ester, sorbitan ester ether, monoglyceride, polyglycerin alkyl esters, fatty acid diethanolamide, alkyl polyether amines, amine oxide, and ethylene glycol distearate.

Examples of the flame retardant include metal hydroxides, phosphorus compounds, nitrogen compounds, layered polyhydrates, antimony compounds, bromine compounds, and bromine-containing epoxy resins.

Examples of the metal hydroxide include aluminum hydroxide, magnesium hydroxide, dawsonite, calcium aluminate, gypsum dihydrate, and calcium hydroxide. Examples of the phosphorus compound include phosphorus esters such as red phosphorus, ammonium polyphosphate, triphenyl phosphate, tricyclohexyl phosphate, and phosphorus; and phosphorus-containing resins such as phosphorus-containing epoxy resin, phosphorus-containing phenoxy resin, and a phosphorus-containing vinyl compound. Examples of the nitrogen compound include melamine compounds such as melamine, melamine cyanurate, melamine isocyanurate, and melamine phosphate; and melamine derivatives prepared by surface-treating the melamine compounds. Examples of the layered polyhydrate include hydrotalcite. Examples of the antimony compound include antimony trioxide and antimony pentoxide. Examples of the bromine compound include decabromodiphenyl ether and triallylisocyanurate hexabromide. Examples of the bromine-containing epoxy resin include tetrabromobisphenol A. In particular, preferably used is a metal oxide, a phosphorus compound, a bromine compound, or a melamine derivative.

Examples of the coloring agent include pigments and dyes such as carbon black, graphite, fullerene, titanium carbon, manganese dioxide, and phthalocyanine.

### (Insulating Sheet)

The process of manufacture of the insulating sheet according to the present invention is not particularly limited. For example, the insulating sheet may be provided by mixing the aforementioned materials to prepare a mixture and then forming the mixture into a sheet through solvent casting or extrusion film formation. It is preferable to perform degassing upon the sheet formation.

The insulating sheet has a glass transition temperature Tg of 25° C. or lower when it is uncured. An insulating sheet having a glass transition temperature of higher than 25° C. may be hard and brittle at room temperature. This may cause poor handleability of the uncured insulating sheet.

The insulating sheet has a bending modulus at 25° C. of preferably 10 to 1,000 MPa, and more preferably 20 to 500 MPa, when it is uncured. If the uncured insulating sheet has a bending modulus of lower than 10 MPa at 25° C., the self supportability at room temperature of the uncured insulating sheet may be remarkably poor, and the handleability of the uncured insulating sheet may be poor. If the insulating sheet has a bending modulus at 25° C. of higher than 1,000 MPa, the elastic modulus of the insulating sheet may not be sufficiently low upon heat bonding. This may cause the cured product of the insulating sheet to insufficiently bond to an adherend, and the adhesion between the cured product of the insulating sheet and the adherend may be poor.

After the insulating sheet is cured, the cured product of the insulating sheet has a bending modulus at 25° C. of preferably 1,000 to 50,000 MPa, and more preferably 5,000 to 30,000 MPa. If the cured product of the insulating sheet has a bending modulus at 25° C. of lower than 1,000 MPa, a laminated structure formed by the use of the insulating sheet, such as a thin laminated substrate or a laminated plate with a copper circuit disposed on both of the surfaces, may be easily bent. Thus, the laminated structure is likely to be damaged due to folding or bending. If having a bending modulus at 25° C. of higher than 50,000 MPa, the cured product of the insulating sheet may be too hard and too brittle. Thus, the cured product of the insulating sheet is likely to suffer clacking.

For example, the bending modulus may be measured with a sample (length: 8 cm, width: 1 cm, thickness: 4 mm) by means of a universal testing apparatus RTC-1310A (produced by ORIENTEC Co., Ltd.) at a span of 6 cm and a rate of 1.5 mm/mm in accordance with JIS K 7111. Upon measuring the bending modulus of the cured product of the insulating sheet, the cured product of the insulating sheet may be prepared by curing the insulating sheet at two temperature steps, that is, at 120° C. for 1 hour and then at 200° C. for 1 hour.

The insulating sheet according to the present invention preferably has a tan δ at 25° C., measured with a rotating dynamic viscoelasticity measuring apparatus, of 0.1 to 1.0 when it is uncured, and the insulating sheet preferably has a maximum tan δ of 1.0 to 5.0 when the uncured insulating sheet is heated from 25° C. to 250° C. The tan δ of the insulating sheet is more preferably 0.1 to 0.5. The maximum value of the tan δ of the insulating sheet is more preferably 1.5 to 4.0.

If the uncured insulating sheet has a tan δ at 25° C. of lower than 0.1, the uncured insulating sheet may has poor flexibility and is likely to be damaged. If the uncured insulating sheet has a tan δ at 25° C. of higher than 1.0, the uncured insulating sheet may be too soft, and the handleability of the uncured insulating sheet may be poor.

If the insulating sheet has a maximum tan δ of lower than 1.0 when the uncured insulating sheet is heated from 25° C. to 250° C., the insulating sheet may insufficiently adhere to an adherend upon heat bonding. If the aforementioned maximum tan δ of the insulating sheet is higher than 5.0, the insulating sheet may have too high fluidity and the insulating sheet may be thin upon heat bonding. Thus, desired dielectric breakdown characteristics may not be obtained.

tan δ at 25° C. of the uncured insulating sheet may be measured with a 2-cm diameter disc-shaped uncured insulating sheet by means of a rotating dynamic viscoelasticity measuring apparatus VAR-100 (produced by REOLOGICA Instruments AB) with a 2-cm diameter parallel plate at a temperature of 25° C., an initial stress of 10 Pa, a frequency of 1 Hz, and a strain of 1% in an oscillation strain controlling mode. Further, the maximum value of the tan δ of the insulating sheet when the uncured insulating sheet is heated from 25° C. to 250° C. may be measured by heating the uncured insulating sheet from 25° C. to 250° C. at a heating rate of 30° C./min under the aforementioned conditions.

In the case where the bending modulus and the tan δ each are in the aforementioned specific range, the handleability of the uncured insulating sheet is remarkably high upon the production and the use thereof. Further, the adhesive strength of the insulating sheet is remarkably high in the case of bonding a high-heat conductor such as a copper foil or an aluminum plate to the electrically conductive layer. Furthermore, in the case where the high-heat conductor has projected and recessed portions on its adhesive surface, the insulating sheet is allowed to highly follow the projected and recessed portions. Thus, voids are less likely to be formed at the adhesive interface, so that the insulating sheet is allowed to have higher thermal conductivity.

In the case where filler having a high thermal conductivity is filled into the insulating adhesive sheet of Patent Document 4 at a high density so as to improve the heat dissipation capability of the insulating adhesive sheet, the insulating adhesive sheet is caused to have a higher elastic modulus, so that the insulating adhesive sheet does not satisfy the parameters of Patent Document 4. In the case where filler having a high thermal conductivity is filled into the insulating adhesive sheet at a high density so as to improve the heat dissipation capability of the insulating adhesive sheet, the parameters of Patent Document 4 may be satisfied if the insulating adhesive sheet contains a large amount of a low-molecular-weight component for adjusting the viscosity of the insulating adhesive sheet. In this case, the uncured insulating adhesive sheet may have too high tackiness, so that the handleability of the insulating adhesive sheet may be poor.

The insulating adhesive sheet of Patent Document 4 contains acryl rubber having a Tg of −10° C. or higher for exerting a stress relaxation property after it is cured. If this rubber is added, however, the cured product of the insulating adhesive sheet may have poor heat resistance. Thus, the insulating adhesive sheet of Patent Document 4 may not be applied to use for heat dissipation in electronic components; in particular, it may not be used in power device applications such as electric vehicles in which a large amount of heat are generated due to an application of a high voltage or a passage of a large current.

In the case where the bending modulus and the tan δ are in the aforementioned specific range, the handleability of the uncured insulating sheet is allowed to be better. Further, the insulating sheet is allowed to be used in power device applications.

The uncured insulating sheet preferably has a reaction ratio of 10% or lower. If the uncured insulating sheet has a reaction ratio of higher than 10%, the uncured insulating sheet may be hard and brittle, so that the handleability of the uncured insulating sheet may be poor at room temperature and the cured product of the insulating sheet may have poor adhesion. The reaction ratio of the insulating sheet may be determined by calculating quantities of heat generated upon curing the insulating sheet at two temperature steps, that is, at 120° C. for 1 hour and then at 200° C. for 1 hour with a differential scanning calorie measuring apparatus.

The thickness of the insulating sheet is not particularly limited. The thickness of the insulating sheet is preferably 10 to 300 μm, more preferably 50 to 200 μm, and further preferably 70 to 120 μm. If the insulating sheet is too thin, the cured product of the insulating sheet may have poor dielectric breakdown characteristics, and thus the insulating property thereof may be poor. If the insulating sheet is too thick, the insulating sheet may have poor heat dissipation capability in the case of bonding a metal material to the electrically conductive layer.

A thick insulating sheet allows the cured product of the insulating sheet to have much better dielectric breakdown characteristics. Here, the insulating sheet according to the present invention allows the cured product of the insulating sheet to have high dielectric breakdown characteristics even when it is thin.

The cured product of the insulating sheet has a thermal conductivity of preferably 1.5 W/m·K or higher, more preferably 2.0 W/m·K or higher, further preferably 3.0 W/m·K or higher, furthermore preferably 5.0 W/m·K or higher, and particularly preferably 7.0 W/m·K or higher. A cured product of the insulating sheet having a too low thermal conductivity may have insufficient heat dissipation capability.

After the insulating sheet is cured, the cured product of the insulating sheet has a dielectric breakdown voltage of 30 kV/mm or higher. The dielectric breakdown voltage of the cured product of the insulating sheet is preferably 40 kV/mm or higher, more preferably 50 kV/mm or higher, further preferably 80 kV/mm or higher, and particularly preferably 100 kV/mm or higher.

The dielectric resin component of the insulating sheet according to the present invention includes: the polymer (A) having an aromatic skeleton, which is excellent in voltage resistance, and a weight average molecular weight of 10,000 or more; the monomer (B) which is at least one of the epoxy monomer (B1) having an aromatic skeleton and a weight average molecular weight of 600 or less and the oxetane monomer (B2) having an aromatic skeleton and a weight average molecular weight of 600 or less; and the curing agent (C) which is a phenol resin, an acid anhydride having an aromatic skeleton or an alicyclic skeleton, a hydrogenated product of the acid anhydride, or a modified product of the acid anhydride, and which is excellent in voltage resistance, in the aforementioned specific amounts. Thus, the insulating resin component itself is allowed to have a dielectric breakdown voltage of higher than 30 kV/mm. It is commonly known that a cured product of the insulating sheet with filler dispersed in the insulating resin component is likely to suffer dielectric breakdown at the interface of the insulating resin component and the filler. In the case where the filler is dispersed well and the insulating resin component surely exists between the filler elements, the interface of the insulating resin component and the filler is made discontinuous inside the insulating sheet, so that the dielectric breakdown voltage of the insulating sheet is retained high. In the case where the filler is insufficiently dispersed and coarse filler agglomerate exists inside the insulating sheet, the interface of the insulating resin component and the filler is made continuous, so that the dielectric breakdown voltage of the insulating sheet is greatly low. Here, that the dielectric breakdown voltage of the cured product of the insulating sheet is lower than 30 kV/mm means that the filler is insufficiently dispersed in the insulating resin component. If the dielectric breakdown voltage of the cured product of the insulating sheet is lower than 30 kV/mm, the filler is insufficiently dispersed in the insulating resin component, so that the cured product of the insulating sheet may have poor adhesion. Further, the strength of the insulating sheet is likely to locally vary, so that the handleability of the uncured insulating sheet may be poor. An insulating sheet having a too low dielectric breakdown voltage may exert an insufficient insulating property when used in large-current applications such as electric power elements.

The cured product of the insulating sheet has a volume resistivity of preferably 10¹⁴ Ω·cm or higher, and more preferably 10¹⁶ Ω·cm or higher. If the volume resistivity is too low, insulation between the electrically conductive layer and the high-heat conductor may not be retained.

The cured product of the insulating sheet has a coefficient of linear thermal expansion of preferably 30 ppm/° C. or lower, and more preferably 20 ppm/° C. or lower. A cured product of the insulating sheet having a too high coefficient of linear thermal expansion may have poor temperature cycle resistance.

### (Multilayer Structure)

The insulating sheet according to the present invention is used for bonding the heat conductor having a thermal conductivity of 10 W/m·K or higher to the electrically conductive layer. Further, the insulating sheet according to the present invention is suitably used as the material of an insulating layer of the multilayer structure in which the electrically conductive layer is laminated on at least one side of the heat conductor having a thermal conductivity of 10 W/m·K or higher via the insulating layer.

The multilayer structure according to the present invention includes the heat conductor having a thermal conductivity of 10 W/m·K or higher; the insulating layer laminated on at least one side of the heat conductor; and the electrically conductive layer laminated on the insulating layer on the other side of the insulating sheet. The insulating layer is formed by curing the insulating sheet according to the present invention.

For example, the multilayer structure may be provided by bonding a metal material to an electrically conductive layer, such as a multilayer plate or a multilayer wiring board with copper circuits provided on both sides thereof, a copper foil, a copper plate, a semiconductor element, or a semiconductor package, via the insulating sheet, and then curing the insulating sheet.

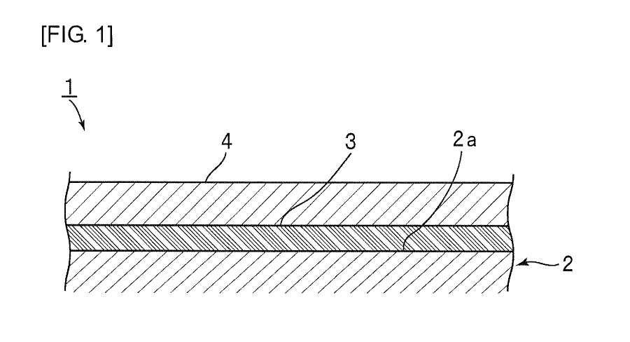

FIG. 1 is a partially-cutout cross-sectional front view schematically showing a multilayer structure according to one embodiment of the present invention.

In a multilayer structure 1 of FIG. 1, a heat conductor 4 is laminated on the surface 2a of an electrically conductive layer 2 serving as a heat source via an insulating layer 3. The insulating layer 3 is formed by curing the insulating sheet of the present invention. The heat conductor 4 is one having a heat conductivity of 10 W/m·K or higher.

In the multilayer structure 1, the insulating layer 3 has a high heat conductivity, so that the insulating layer 3 is likely to transmit heat from the side of the electrically conductive layer 2 to the heat conductor 4. In the multilayer structure 1, the heat conductor 4 effectively dissipates heat.

The heat conductor having the thermal conductivity of 10 W/m·K or higher is not particularly limited. Examples of the heat conductor having the thermal conductivity of 10 W/m·K or higher include aluminum, copper, alumina, beryllia, silicon carbide, silicon nitride, aluminum nitride, and a graphite sheet. In particular, the heat conductor having the thermal conductivity of 10 W/m·K or higher is preferably copper or aluminum. Copper and aluminum are excellent in heat dissipation capability.

The insulating sheet of the present invention is suitably used for bonding a heat conductor having a thermal conductivity of 10 W/m·K or higher to an electrically conductive layer of a semiconductor device with a semiconductor element mounted on a substrate. The insulating sheet of the present invention is also suitably used for bonding a heat conductor having a thermal conductivity of 10 W/m·K or higher to an electrically conductive layer of an electronic component device with an electronic component other than semiconductor elements mounted on a substrate.

In the case where the semiconductor element is a power supply device element for large current applications, a cured product of the insulating sheet is required to have a much more excellent insulating property or heat resistance. Thus, the insulating sheet of the present invention is suitably used in such applications.

The present invention is clearly disclosed hereinbelow with reference to, but not limited to, specific examples and comparative examples.

The following materials were prepared.

### [Polymer (A)]

(1) Epoxy group-containing styrene resin (trade name: MARPROOFG-1010S, produced by NOF Corp., Mw=100,000, Tg=93° C., ratio of aromatic skeleton in 100% by weight of the whole skeleton: 65% by weight)

(2) Bisphenol A phenoxy resin (trade name: E1256, produced by Japan Epoxy Resins Co., Ltd., Mw=51,000, Tg=98° C., ratio of aromatic skeleton in 100% by weight of the whole skeleton: 51% by weight)

(3) Highly heat-resistant phenoxy resin (trade name: FX-293, produced by Tohto Kasei Co., Ltd., Mw=43,700, Tg=163° C., ratio of aromatic skeleton in 100% by weight of the whole skeleton: 70% by weight)

[Polymers Other than Polymer (a)]

(1) Epoxy group-containing acryl resin 1 (trade name: MARPROOF G-0130S, produced by NOF Corp., Mw=9,000, Tg=69° C.)

(2) Acrylonitrile-butadiene rubber (trade name: Nipol 1001, produced by ZEON Corp., Mw=30,000, ratio of aromatic skeleton in 100% by weight of the whole skeleton: 0% by weight)

(3) Epoxy group-containing acryl resin 2 (trade name: MARPROOF G-01100, produced by NOF Corp., Mw=12,000, Tg=47° C., ratio of aromatic skeleton in 100% by weight of the whole skeleton: 0% by weight)

### [Epoxy Monomer (B1)]

(1) Bisphenol A liquid epoxy resin (trade name: EPIKOTE 828US, produced by Japan Epoxy Resins Co., Ltd., Mw=370)

(2) Bisphenol F liquid epoxy resin (trade name: EPIKOTE 806L, produced by Japan Epoxy Resins Co., Ltd., Mw=370)

(3) Trifunctional glycidyl amine liquid epoxy resin (trade name: EPIKOTE 630, produced by Japan Epoxy Resins Co., Ltd., Mw=300)

(4) Fluorene skeleton epoxy resin (trade name: Oncoat EX1011, produced by Osaka Gas Chemicals Co., Ltd., Mw=486)

(5) Naphthalene skeleton liquid epoxy resin (trade name: EPICLON HP-4032D, produced by Dainippon Ink and Chemicals, Corp., Mw=304)

### [Oxetane Monomer (B2)]

(1) Benzene skeleton oxetane resin (trade name: ETERNACOLL OXTP, produced by Ube Industries, Ltd., Mw=362.4)

[Monomers Other than Monomer (B)]

(1) Hexahydro phthalate skeleton liquid epoxy resin (trade name: AK-601, produced by Nippon Kayaku Co., Ltd., Mw=284)

(2) Bisphenol A solid epoxy resin (trade name: 1003, produced by Japan Epoxy Resins Co., Ltd., Mw=1300)

### [Curing Agent (C)]

(1) Alicyclic skeleton acid anhydride (trade name: MH-700, produced by New Japan Chemical Co., Ltd.)

(2) Aromatic skeleton acid anhydride (trade name: SMA resin EF60, produced by Sartomer Japan Inc.)

(3) Polyalicyclic skeleton acid anhydride (trade name: HNA-100, produced by New Japan Chemical Co., Ltd.)

(4) Terpene skeleton acid anhydride (trade name: EPIKURE YH-306, produced by Japan Epoxy Resins Co., Ltd.)

(5) Biphenyl skeleton phenol resin (trade name: MEH-7851-S, produced by Meiwa Plastic Industries, Ltd.)

(6) Allyl skeleton phenol resin (trade name: YLH-903, produced by Japan Epoxy Resins Co., Ltd.)

(7) Triazine skeleton phenol resin (trade name: PHENOLITE KA-7052-L2, produced by Dainippon Ink and Chemicals, Corp.)

(8) Melamine skeleton phenol resin (trade name: PS-6492, produced by Gunei Chemical Industry Co., Ltd.)

(9) Isocyanurate-modified solid dispersed imidazole (imidazole curing accelerator, trade name: 2MZA-PW, produced by Shikoku Chemicals Corp.)

### [Filler (D)]

(1) Surface-hydrophobic fumed silica (trade name: MT-10, produced by Tokuyama Corp., average particle size: 15 nm, thermal conductivity: 1.3 W/m·K)

(2) Spherical alumina 1 (trade name: DAM-10, produced by Denki Kagaku Kogyo K. K., average particle size: 10 μm, thermal conductivity: 36 W/m·K)

(3) Boron nitride (trade name: UHP-1, produced by Showa Denko K.K., average particle size: 8 μm, thermal conductivity: 60 W/m·K)

(4) Aluminum nitride (trade name: TOYALNITE-FLX, produced by TOYO ALUMINIUM K.K., average particle size: 14 μm, thermal conductivity: 200 W/m·K)

(5) Silicon carbide (trade name: SHINANO-RUNDUM GP#700, produced by Shinano Electric Refining Co., Ltd., average particle size: 17 μm)

(6) Spherical alumina 2 (Spherical filler (D1), trade name: AKP-30, produced by Sumitomo Chemical Co., Ltd., average particle size: 0.4 μm, aspect ratio: 1.1 to 2.0, thermal conductivity: 36 W/m·K)

(7) Spherical magnesium oxide (spherical filler (D1), trade name: SMO Small Particle, produced by Sakai Chemical Industry Co., Ltd., average particle size: 0.1 μm, aspect ratio: 1.1 to 1.5, thermal conductivity: 42 W/m·K)

(8) Spherical alumina 3 (Spherical filler (D2), trade name: DAM-05, produced by Denki Kagaku Kogyo Kabushiki Kaisha, average particle size: 5 μm, aspect ratio: 1 to 1.2, thermal conductivity: 36 W/m·K)

(9) Spherical aluminum nitride 1 (trade name: TOYALNITE-FLC, produced by TOYO ALUMINIUM K.K., average particle size: 3.7 aspect ratio: 1 to 1.3, thermal conductivity: 200 W/m·K)

(10) Spherical alumina 4 (Spherical filler (D3), trade name: AO-820, produced by Admatechs Co. Ltd., average particle size: 20 μm, aspect ratio: 1 to 1.1, thermal conductivity: 36 W/m·K)

(11) Spherical aluminum nitride 2 (trade name: TOYALNITE-FLD, produced by TOYO ALUMINIUM K.K., average particle size: 30 μm, aspect ratio: 1 to 1.3, thermal conductivity: 200 W/m·K)

(12) Spherical alumina 5 (trade name: AA-07, produced by Sumitomo Chemical Co., Ltd., average particle size: 0.7 μm, aspect ratio: 1.1 to 2.0, thermal conductivity: 36 W/m·K)

(13) 5-μm Alumina (crushed filler (D4), trade name: LT300C, produced by Nippon Light Metal Co., Ltd., average particle size: 5 μm)

(14) 2-μm Alumina (crushed filler (D4), trade name: LS-242C, produced by Nippon Light Metal Co., Ltd., average particle size: 2 μm)

(15) 1.2-μm Aluminum nitride (crushed filler (D4), trade name: JC, produced by TOYO ALUMINIUM K.K., average particle size: 1.2 μm)

(16) 29-μm Alumina (crushed filler (D4), trade name: LA400, produced by Pacific Rundum Co., Ltd., average particle size: 29 μm)

### [Dispersing Agent (F)]

(1) Acrylic dispersing agent (trade name: Disperbyk-2070, produced by BYK Japan KK, containing a carboxyl group having a pKa of 4)

(2) Polyether dispersing agent (trade name: ED151, produced by Kusumoto Chemicals, Ltd., containing a phosphate group having a pKa of 7)

[Dispersing Agent Other than the Dispersing Agent (F)]

(1) Nonionic dispersing agent (trade name: D-90, produced by Kyoeisha Chemical Co., Ltd., free from a functional group having a hydrogen atom capable of forming a hydrogen bond)

### [Granular Rubber (E)]

(1) Core-shell type fine granular rubber (trade name: KW4426, produced by Mitsubishi Rayon Co., Ltd., having a shell consisting of methyl methacrylate and a core consisting of butyl acrylate, average particle size: 5 μm)

(2) Fine granular silicon rubber (trade name: TORAYFIL E601, produced by Dow Corning Toray Co., Ltd., average particle size: 2 μm)

### [Additive]

(1) Epoxy silane coupling agent (trade name: KBE403, produced by Shin-Etsu Chemical Co., Ltd.)

### [Solvent]

(1) Methylethyl ketone

### Example 1

The compounds were mixed and kneaded with one another at a ratio shown in the following Table 1 with a homodisper to prepare an insulating material.

The prepared insulating material was applied to a 50-μm thick release PET sheet so that the thickness of the insulating material was 100 μm. The applied insulating material was dried for 30 minutes in a 90° C. oven to prepare an insulating sheet on the PET sheet.

### Examples 2 to 18, Reference Example 1, and Comparative Examples 1 to 3

Except that the types and amounts of the compounds were changed as shown in the following Tables 1 to 3, insulating materials were prepared in the same manner as in Example 1 and insulating sheets each were prepared on the PET film.

### Evaluations on insulating sheets of Examples 2 to 18, Reference Example 1, and Comparative Examples 1 to 3

### (1) Handleability

A multilayer sheet including the PET sheet and the insulating sheet formed on the PET sheet was cut out into a plane shape having a size of 460 mm×610 mm to provide a test sample. By the use of the provided test sample, the handleability upon peeling the uncured insulating sheet off the PET film at room temperature (23° C.) was evaluated according to the following criteria.

### [Evaluation Criteria of Handleability]

o: The insulating sheet was not deformed and was easily peeled off.

Δ: The insulating sheet was peeled off, but the sheet was elongated or broken.

x: The insulating sheet was not peeled off.

### (2) Glass Transition Temperature

The glass transition temperature of the uncured insulating sheet was measured at a temperature-rise rate of 3° C./min with a differential scanning calorie measuring apparatus “DSC220C” produced by Seiko Instruments Inc.

### (3) Thermal Conductivity

The thermal conductivity of the insulating sheet was measured with a thermal conductivity meter “Quick Thermal Conductivity Meter QTM-500” produced by Kyoto Electronics Manufacturing Co., Ltd.

### (4) Peel Strength

The insulating sheet was sandwiched between a 1-mm thick aluminum plate and a 35-μm thick electrolytic copper foil. Then, the insulating sheet was press-cured at 120° C. for 1 hour and at 200° C. for 1 hour while retaining a pressure at 4 MPa with a vacuum press to prepare a copper clad laminated plate. The copper foil of the prepared copper clad laminated plate was etched to provide a 10-mm width copper foil band. Thereafter, the peel strength was measured upon peeling the copper foil off the substrate at an angle of 90° and at a peeling rate of 50 mm/min.

### (5) Dielectric Breakdown Voltage

The insulating sheet was cut out into a plane shape having a size of 100 mm×100 mm to prepare a test sample. The prepared test sample was cured for 1 hour in a 120° C. oven and for 1 hour in a 200° C. oven to prepare a cured product of the insulating sheet. The cured product of the insulating sheet was subjected to an application of an alternating voltage so that the voltage rose at a rate of 1 kV/sec with a voltage resistance testing apparatus (MODE L7473, produced by EXTECH Electronics). The voltage at which the insulating sheet was broken was regarded as a dielectric breakdown voltage.

### (6) Solder Heat Resistance

The insulating sheet was sandwiched between a 1-mm thick aluminum plate and a 35-μm thick electrolytic copper foil. Then, the insulating sheet was press-cured at 120° C. for 1 hour and at 200° C. for 1 hour while retaining a pressure at 4 MPa with a vacuum press to prepare a copper clad laminated plate. The prepared copper clad laminated plate was cut out into a size of 50 mm×60 mm to prepare a test sample. The prepared test sample was allowed to float on a 288° C. solder bath so that the copper foil side was put downward. The time period until the copper foil was expanded or peeled off was measured, and the solder heat resistance was evaluated according to the following criteria.

### [Evaluation Criteria of Solder Heat Resistance]

o: No expansion or peeling occurred even after 3 minutes.

Δ: Expansion or peeling occurred after 1 minute and before 3 minutes.

x: Expansion or peeling occurred before 1 minute.

### (7) Reaction Ratio

The prepared insulating sheet was heated to 120° C. at an initial temperature of 30° C. and a temperature-rise rate of 8° C./min with a differential scanning calorie measuring apparatus “DSC220C” produced by Seiko Instruments Inc., and then kept for 1 hour. The insulating sheet was further heated to 200° C. at a temperature-rise rate of 8° C./min, and then kept for 1 hour. The quantity of heat generated upon curing the insulating sheet through these two steps (hereinafter, referred to as Heat quantity A) was measured.

The insulating material used for preparing the insulating sheet of the examples and the comparative examples was applied to a 50-μm thick release PET sheet so that the thickness of the insulating material was 100 μm. Then, except that the insulating material was dried for 1 hour under normal-temperature (23° C.) and vacuum (0.01 atm) conditions, that is, without heating, the dried uncured insulating sheet was prepared in the same manner as in the examples and the comparative examples. The quantity of heat generated upon curing the insulating sheet through the two steps (hereinafter, referred to as Heat quantity B) was measured in the same manner as for measuring Heat quantity A. By the use of the obtained Heat quantities A and B and the following equation, the reaction ratio of the uncured insulating sheet was calculated.

Reaction ratio (%)=[1−(Heat quantity A/Heat quantity B)]×100

Tables 1 to 3 show the results.

TABLE 1

| | | | Examples | | | | | | | |
|---|---|---|---|---|---|---|---|---|---|---|
| | | | 1 | 2 | 3 | 4 | 5 | 6 | 7 | 8 |
| Components | Polymer (A) | Epoxy group-containing styrene resin | 5 | | | | | | | |
| (parts by | | Bisphenol A phenoxy resin | | 6 | | | | | | |
| weight) | | Highly heat-resistant phenoxy resin | | | 6 | 6 | 6 | 6 | 6 | 6 |
| | Polymer other than | Epoxy group-containing acryl resin 1 | | | | | | | | |
| | polymer (A) | | | | | | | | | |
| | Epoxy monomer (B1) | Bisphenol A liquid epoxy resin | 5 | 5 | 5 | | | | | 5 |
| | | Bisphenol F liquid epoxy resin | | | | 5 | | | | |
| | | Trifunctional glycidyl diamine liquid epoxy resin | | | | | 5 | | | |
| | | Fluorene skeleton epoxy resin | | | | | | 5 | | |
| | | Naphthalene skeleton liquid epoxy resin | | | | | | | 5 | |
| | Monomer other than | Hexahydro phthalate skeleton liquid epoxy resin | 2 | 1 | 1 | 1 | 1 | 1 | 1 | 1 |
| | monomer (B) | Bisphenol A solid epoxy resin | | | | | | | | |
| | Curing agent (C) | Alicyclic skeleton acid anhydride | 4 | 4 | 4 | 4 | 4 | 4 | 4 | |
| | | Aromatic skeleton acid anhydride | | | | | | | | 4 |
| | | Polyalicyclic skeleton acid anhydride | | | | | | | | |
| | | Terpene skeleton acid anhydride | | | | | | | | |
| | | Biphenyl skeleton phenol resin | | | | | | | | |
| | | Allyl skeleton phenol resin | | | | | | | | |
| | | Triazine skeleton phenol resin | | | | | | | | |
| | | Melamine skeleton phenol resin | | | | | | | | |
| | | Isocyanurate-modified solid dispersed imidazole | 1 | 1 | 1 | 1 | 1 | 1 | 1 | 1 |
| | Filler (D) | Surface-hydrophobic fumed silica | 1 | 1 | 1 | 1 | 1 | 1 | 1 | 1 |
| | | Spherical alumina 1 | 80 | 80 | 80 | 80 | 80 | 80 | 80 | 80 |
| | | Boron nitride | | | | | | | | |
| | | Aluminum nitride | | | | | | | | |
| | | Silicon carbide | | | | | | | | |
| | Granular rubber (E) | Core-shell type fine granular rubber | 1 | 1 | 1 | 1 | 1 | 1 | 1 | 1 |
| | | Fine granular silicon rubber | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |

| Ratio of polymer (A) (% by weight) *1 | | 26 | 32 | 32 | 32 | 32 | 32 | 32 | 32 |
|---|---|---|---|---|---|---|---|---|---|
| Ratio of monomer (B) (% by weight) *1 | | 26 | 26 | 26 | 26 | 26 | 26 | 26 | 26 |
| Ratio of filler (D) (% by volume) *2 | | 57 | 57 | 57 | 57 | 57 | 57 | 57 | 57 |
| Evaluations | Handleability | ◯ | ◯ | ◯ | ◯ | ◯ | ◯ | ◯ | ◯ |
| | Glass transition temperature (° C.) | 12 | 8 | 11 | 10 | 12 | 14 | 9 | 18 |
| | Thermal conductivity (W/m · K) | 2 | 2.1 | 2.4 | 2.3 | 2.3 | 2.6 | 2.5 | 2.2 |
| | Peel strength (N/cm) | 16 | 18 | 21 | 20 | 19 | 18 | 19 | 18 |
| | Dielectric breakdown voltage (kV/mm) | 41 | 44 | 60 | 55 | 61 | 65 | 70 | 62 |
| | Solder heat resistance (288° C.) | ◯ | ◯ | ◯ | ◯ | ◯ | ◯ | ◯ | ◯ |
| | Reaction ratio (%) | 8 | 6 | 5 | 6 | 8 | 7 | 8 | 6 |

*1 The ratio in 100% by weight of all the resin components in the insulating sheet
*2 The ratio in 100% by volume of the insulating sheet

TABLE 2

| | | | Examples | | | | | | | |
|---|---|---|---|---|---|---|---|---|---|---|
| | | | 9 | 10 | 11 | 12 | 13 | 14 | 15 | 16 |
| Components | Polymer (A) | Epoxy group-containing styrene resin | | | | | | | | |
| (parts by | | Bisphenol A phenoxy resin | | | | | | | | |
| weight) | | Highly heat-resistant phenoxy resin | 6 | 6 | 6 | 6 | 6 | 6 | 10 | 6 |
| | Polymer other than | Epoxy group-containing acryl resin 1 | | | | | | | | |
| | polymer (A) | | | | | | | | | |
| | Epoxy monomer (B1) | Bisphenol A liquid epoxy resin | 5 | 5 | 5 | 5 | 5 | 5 | 16 | 5 |
| | | Bisphenol F liquid epoxy resin | | | | | | | | |
| | | Trifunctional glycidyl diamine liquid epoxy resin | | | | | | | | |
| | | Fluorene skeleton epoxy resin | | | | | | | | |
| | | Naphthalene skeleton liquid epoxy resin | | | | | | | | |
| | Monomer other than | Hexahydro phthalate skeleton liquid epoxy resin | 1 | 1 | 1 | 1 | 1 | 1 | | 1 |
| | monomer (B) | Bisphenol A solid epoxy resin | | | | | | | | |
| | Curing agent (C) | Alicyclic skeleton acid anhydride | | | | | | | | |
| | | Aromatic skeleton acid anhydride | | | | | | | | |
| | | Polyalicyclic skeleton acid anhydride | 4 | | | | | | | |
| | | Terpene skeleton acid anhydride | | 4 | | | | | 8 | 4 |
| | | Biphenyl skeleton phenol resin | | | 4 | | | | | |
| | | Allyl skeleton phenol resin | | | | 4 | | | | |
| | | Triazine skeleton phenol resin | | | | | 4 | | | |
| | | Melamine skeleton phenol resin | | | | | | 4 | | |
| | | Isocyanurate-modified solid dispersed imidazole | 1 | 1 | 1 | 1 | 1 | 1 | 2 | 1 |
| | Filler (D) | Surface-hydrophobic fumed silica | 1 | 1 | 1 | 1 | 1 | 1 | 1 | 1 |
| | | Spherical alumina 1 | 80 | 80 | 80 | 80 | 80 | 80 | | |
| | | Boron nitride | | | | | | | 60 | |
| | | Aluminum nitride | | | | | | | | 80 |
| | | Silicon carbide | | | | | | | | |
| | Granular rubber (E) | Core-shell type fine granular rubber | 1 | 1 | 1 | 1 | 1 | 1 | 2 | 1 |
| | | Fine granular silicon rubber | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |

| Ratio of polymer (A) (% by weight) *1 | | 32 | 32 | 32 | 32 | 32 | 32 | 26 | 32 |
|---|---|---|---|---|---|---|---|---|---|
| Ratio of monomer (B) (% by weight) *1 | | 26 | 26 | 26 | 26 | 26 | 26 | 41 | 26 |
| Ratio of filler (D) (% by volume) *2 | | 57 | 57 | 57 | 57 | 57 | 57 | 32 | 57 |
| Evaluations | Handleability | ◯ | ◯ | ◯ | ◯ | ◯ | ◯ | ◯ | ◯ |
| | Glass transition temperature (° C.) | 5 | 6 | 17 | 10 | 13 | 9 | 12 | 10 |
| | Thermal conductivity (W/m · K) | 2.5 | 2.6 | 2.1 | 2.2 | 2.3 | 2.4 | 3.8 | 4.2 |
| | Peel strength (N/cm) | 22 | 23 | 15 | 17 | 18 | 21 | 16 | 18 |
| | Dielectric breakdown voltage (kV/mm) | 63 | 64 | 62 | 58 | 58 | 60 | 42 | 50 |
| | Solder heat resistance (288° C.) | ◯ | ◯ | ◯ | ◯ | ◯ | ◯ | ◯ | ◯ |
| | Reaction ratio (%) | 7 | 5 | 8 | 9 | 7 | 7 | 6 | 7 |

*1 The ratio in 100% by weight of all the resin components in the insulating sheet
*2 The ratio in 100% by volume of the insulating sheet

TABLE 3

| | | | | | | Comparative | | |
|---|---|---|---|---|---|---|---|---|
| | | | Reference | Examples | | Examples | | |
| | | | Example 1 | 17 | 18 | 1 | 2 | 3 |
| Components (parts by weight) | Polymer (A) | Epoxy group-containing styrene resin | | | | 5 | | 1 |
| | | Bisphenol A phenoxy resin | | | | | | |
| | | Highly heat-resistant phenoxy resin | 10 | 6 | 3 | | | |
| | Polymer other than | Epoxy group-containing acryl resin 1 | | | | | 5 | |
| | polymer (A) | | | | | | | |
| | Epoxy monomer (B1) | Bisphenol A liquid epoxy resin | 15 | 5 | 3 | | 5 | 9 |
| | | Bisphenol F liquid epoxy resin | | | | | | |
| | | Trifunctional glycidyl diamine liquid epoxy resin | | | | | | |
| | | Fluorene skeleton epoxy resin | | | | | | |
| | | Naphthalene skeleton liquid epoxy resin | | | | | | |
| | Monomer other than | Hexahydro phthalate skeleton liquid epoxy resin | 2 | 1 | 1 | 2 | 2 | |
| | monomer (B) | Bisphenol A solid epoxy resin | | | | 5 | | |
| | Curing agent (C) | Alicyclic skeleton acid anhydride | | | | 4 | 4 | 6 |
| | | Aromatic skeleton acid anhydride | | | | | | |
| | | Polyalicyclic skeleton acid anhydride | | | | | | |
| | | Terpene skeleton acid anhydride | 8 | 4 | 2 | | | |
| | | Biphenyl skeleton phenol resin | | | | | | |
| | | Allyl skeleton phenol resin | | | | | | |
| | | Triazine skeleton phenol resin | | | | | | |
| | | Melamine skeleton phenol resin | | | | | | |
| | | Isocyanurate-modified solid dispersed imidazole | 2 | 1 | 1 | 1 | 1 | 1 |
| | Filler (D) | Surface-hydrophobic fumed silica | 1 | 1 | 1 | 1 | 1 | 1 |
| | | Spherical alumina 1 | | 80 | 87 | 80 | 80 | 80 |
| | | Boron nitride | | | | | | |
| | | Aluminum nitride | | | | | | |
| | | Silicon carbide | 60 | | | | | |
| | Granular rubber (E) | Core-shell type fine granular rubber | 1 | | 1 | | | |
| | | Fine granular silicon rubber | | 1 | | 1 | 1 | 1 |
| | Additive | Epoxy silane coupling agent | 1 | 1 | 1 | 1 | 1 | 1 |
| | Solvent | Methylethyl ketone | 20 | 20 | 20 | 20 | 20 | 20 |

| Ratio of polymer (A) (% by weight) *1 | | 26 | 32 | 25 | 26 | 0 | 5 |
|---|---|---|---|---|---|---|---|
| Ratio of monomer (B) (% by weight) *1 | | 38 | 26 | 25 | 0 | 26 | 47 |
| Ratio of filler (D) (% by volume) *2 | | 32 | 57 | 69 | 57 | 57 | 57 |
| Evaluations | Handleability | ◯ | ◯ | ◯ | X | X | X |
| | Glass transition temperature (° C.) | 11 | 8 | 9 | 28 | 5 | 2 |
| | Thermal conductivity (W/m · K) | 3.4 | 2.3 | 3 | 2.1 | 2.5 | 2.6 |
| | Peel strength (N/cm) | 14 | 20 | 15 | 12 | 24 | 25 |
| | Dielectric breakdown voltage (kV/mm) | 25 | 60 | 45 | 58 | 63 | 60 |
| | Solder heat resistance (288° C.) | ◯ | ◯ | ◯ | ◯ | ◯ | ◯ |
| | Reaction ratio (%) | 7 | 6 | 5 | 12 | 8 | 9 |

*1 The ratio in 100% by weight of all the resin components in the insulating sheet
*2 The ratio in 100% by volume of the insulating sheet

### Examples 19 to 44 and Comparative Examples 4 to 8

Except that the types and amounts of the compounds were changed as shown in the following Tables 4 to 7, insulating materials were prepared in the same manner as in Example 1 and insulating sheets each were prepared on the PET film.

### Evaluations on Insulating Sheets of Examples 19 to 44 and Comparative Examples 4 to 8

The insulating sheets were evaluated for the aforementioned evaluation items (1) handleability, (2) glass transition temperature, (4) peel strength, (5) dielectric breakdown voltage, and (7) reaction ratio. Further, the insulating sheets were evaluated for the following evaluation items (3-2) thermal conductivity, (6-2) solder heat resistance, and (8) filler variation.

### (3-2) Thermal Conductivity

The insulating sheet was heated to be cured at 120° C. for 1 hour and then at 200° C. for 1 hour in an oven, and thereby a cured product of the insulating sheet was prepared. The thermal conductivity of the prepared cured product of the insulating sheet was measured with a thermal conductivity meter “Quick Thermal Conductivity Meter QTM-500” produced by Kyoto Electronics Manufacturing Co., Ltd.

### (6-2) Solder Heat Resistance

Except that the evaluation criteria of the solder heat resistance were changed as follows, the solder heat resistance was evaluated in the same manner as in the evaluation item (6) solder heat resistance.

### [Evaluation Criteria of Solder Heat Resistance]

oo (double circle): No expansion or peeling occurred after 10 minutes.

o: Expansion or peeling occurred after 3 minutes and before 10 minutes.

Δ: Expansion or peeling occurred after 1 minute and before 3 minutes.

x: Expansion or peeling occurred before 1 minute.

### (8) Particle Size Distribution of Filler

The particle size distribution of the whole filler (D) contained in the insulating sheet was measured with a laser diffractive particle size distribution measuring apparatus. Based on the measuring result, the cumulative volume of the filler (D) was determined starting from a smaller particle size. Thus, the cumulative volume % value at each particle size of 0.1 μm, 0.5 μm, 2.0 μm, 6.0 μm, and 10.0 μm was determined.

Tables 4 to 7 show the results.

TABLE 4

| | | | Examples | | | | | | | |
|---|---|---|---|---|---|---|---|---|---|---|
| | | | 19 | 20 | 21 | 22 | 23 | 24 | 25 | 26 |
| Components | Polymer (A) | Epoxy group-containing styrene resin | | | | | | | | |
| (parts by | | Bisphenol A phenoxy resin | 4 | 4 | 4 | 4 | 4 | 4 | 2 | |
| weight) | | Highly heat-resistant phenoxy resin | | | | | | | | 4 |
| | Polymer | Epoxy group-containing acryl resin 1 | | | | | | | | |
| | other than polymer (A) | | | | | | | | | |
| | Epoxy monomer (B1) | Bisphenol A liquid epoxy resin | 2 | 2 | 2 | 2 | 2 | 2 | 1 | 2 |
| | | Bisphenol F liquid epoxy resin | | | | | | | | |
| | | Trifunctional glycidyl diamine liquid epoxy resin | | | | | | | | |
| | | Fluorene skeleton epoxy resin | | | | | | | | |
| | | Naphthalene skeleton liquid epoxy resin | | | | | | | | |
| | Oxetane monomer (B2) | Benzene skeleton oxetane resin | | | | | | | | |
| | Monomer | Hexahydro phthalate skeleton liquid epoxy resin | 0.5 | 0.5 | 0.5 | 0.5 | 0.5 | 0.5 | 0.5 | 0.5 |
| | other than monomer (B) | Bisphenol A solid epoxy resin | | | | | | | | |
| | Curing agent (C) | Alicyclic skeleton acid anhydride | 2 | 2 | 2 | 2 | 2 | 2 | 1 | 2 |
| | | Aromatic skeleton acid anhydride | | | | | | | | |
| | | Polyalicyclic skeleton acid anhydride | | | | | | | | |
| | | Terpene skeleton acid anhydride | | | | | | | | |
| | | Biphenyl skeleton phenol resin | | | | | | | | |
| | | Allyl skeleton phenol resin | | | | | | | | |
| | | Triazine skeleton phenol resin | | | | | | | | |
| | | Melamine skeleton phenol resin | | | | | | | | |
| | | Isocyanurate-modified solid dispersed imidazole | 0.5 | 0.5 | 0.5 | 0.5 | 0.5 | 0.5 | 0.5 | 0.5 |
| | Spherical filler (D1) | Spherical alumina 2 (average particle size: 0.4 μm) | 10 | | 10 | 10 | 10 | | 14 | 10 |
| | | Spherical magnesium oxide (average | | 10 | | | | 10 | | |
| | | particle size: 0.1 μm) | | | | | | | | |
| | Spherical filler (D2) | Spherical alumina 3 (average particle size: 5 μm) | 40 | 40 | | 40 | | | 40 | 40 |
| | | Spherical aluminum nitride 1 (average | | | 40 | | 40 | 40 | | |
| | | particle size: 3.7 μm) | | | | | | | | |
| | Spherical filler (D3) | Spherical alumina 4 (average particle size: 20 μm) | 40 | 40 | 40 | | | | 40 | 40 |
| | | Spherical aluminum nitride 2 (average | | | | 40 | 40 | 40 | | |
| | | particle size: 30 μm) | | | | | | | | |
| | Filler (D) | Spherical alumina 5 (average particle size: 0.7 μm) | | | | | | | | |
| | other than fillers | | | | | | | | | |
| | (D1) to (D3) | | | | | | | | | |
| | Dispersing agent (F) | Acrylic dispersing agent | | | | | | | | |
| | | Polyether dispersing agent | | | | | | | | |
| | Dispersing agent | Nonionic dispersing agent | | | | | | | | |
| | other than dispersing | | | | | | | | | |
| | agent (F) | | | | | | | | | |
| | Granular rubber (E) | Core-shell type fine granular rubber | | | | | | | | |
| | | Fine granular silicon rubber | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |
| Ratio of polymer (A) (% by weight) *1 | | | 40 | 40 | 40 | 40 | 40 | 40 | 33 | 40 |
| Ratio of monomer (B) (% by weight) *1 | | | 20 | 20 | 20 | 20 | 20 | 20 | 17 | 20 |
| Ratio of spherical filler (D1) (% by volume) *2 | | | 11 | 11 | 13 | 11 | 9.4 | 11 | 15 | 11 |
| Ratio of spherical filler (D2) (% by volume) *2 | | | 44.5 | 44.5 | 43.5 | 41 | 45.3 | 44.5 | 42.5 | 44.5 |
| Ratio of spherical filler (D3) (% by volume) *2 | | | 44.5 | 44.5 | 43.5 | 48 | 45.3 | 44.5 | 42.5 | 44.5 |
| Total ratio of filler (D1), (D2), and (D3) (% by volume) *3 | | | 73.6 | 73.6 | 74 | 75.1 | 76.5 | 76.7 | 82.8 | 73.6 |
| Ratio of filler (D) (% by volume) *3 | | | 73.6 | 73.6 | 74 | 75.1 | 76.5 | 76.7 | 82.8 | 73.6 |
| Evaluations | Handleability | | ◯ | ◯ | ◯ | ◯ | ◯ | ◯ | ◯ | ◯ |
| | Glass transition temperature (° C.) | | 13 | 14 | 12 | 10 | 14 | 15 | 15 | 16 |
| | Thermal conductivity (W/m · K) | | 4.2 | 4.5 | 5.3 | 5.5 | 6.5 | 6.9 | 6.3 | 4.4 |
| | Peel strength (N/cm) | | 17 | 15 | 18 | 19 | 20 | 16 | 14 | 17 |
| | Dielectric breakdown voltage (kV/mm) | | 48 | 42 | 47 | 50 | 51 | 44 | 32 | 61 |
| | Solder heat resistance (288° C.) | | ⊚ | ⊚ | ⊚ | ⊚ | ⊚ | ⊚ | ⊚ | ⊚ |
| | Reaction ratio (%) | | 6 | 5 | 6 | 6 | 5 | 6 | 5 | 5 |
| | Cumulative volume % | (0.1 μm) | 0 | 4 | 0 | 1 | 1 | 5 | 2 | 0 |
| | of filler | (0.5 μm) | 3 | 5 | 3 | 4 | 3 | 6 | 5 | 3 |
| | | (2.0 μm) | 4 | 5 | 5 | 5 | 6 | 6 | 5 | 3 |
| | | (6.0 μm) | 35 | 34 | 50 | 35 | 30 | 33 | 37 | 35 |
| | | (10.0 μm) | 60 | 61 | 63 | 57 | 60 | 62 | 64 | 59 |
| | | (40.0 μm) | 95 | 96 | 97 | 100 | 100 | 100 | 98 | 95 |

*1 The ratio in 100% by weight of all the resin components in the insulating sheet
*2 The ratio in 100% by volume of the filler (D)
*3 The ratio in 100% by volume of the insulating sheet

TABLE 5

| | | | Examples | | | | | | | |
|---|---|---|---|---|---|---|---|---|---|---|
| | | | 27 | 28 | 29 | 30 | 31 | 32 | 33 | 34 |
| Components | Polymer (A) | Epoxy group-containing styrene resin | 4 | | | | | | | |
| (parts by | | Bisphenol A phenoxy resin | | 4 | 4 | 4 | 4 | 4 | 4 | 4 |
| weight) | | Highly heat-resistant phenoxy resin | | | | | | | | |
| | Polymer | Epoxy group-containing acryl resin 1 | | | | | | | | |
| | other than polymer (A) | | | | | | | | | |
| | Epoxy monomer (B1) | Bisphenol A liquid epoxy resin | 2 | | | | | | 2 | 2 |
| | | Bisphenol F liquid epoxy resin | | 2 | | | | | | |
| | | Trifunctional glycidyl diamine liquid epoxy resin | | | 2 | | | | | |
| | | Fluorene skeleton epoxy resin | | | | 2 | | | | |
| | | Naphthalene skeleton liquid epoxy resin | | | | | 2 | | | |
| | Oxetane monomer (B2) | Benzene skeleton oxetane resin | | | | | | 2 | | |
| | Monomer | Hexahydro phthalate skeleton liquid epoxy resin | 0.5 | 0.5 | 0.5 | 0.5 | 0.5 | 0.5 | 0.5 | 0.5 |
| | other than monomer (B) | Bisphenol A solid epoxy resin | | | | | | | | |
| | Curing agent (C) | Alicyclic skeleton acid anhydride | 2 | 2 | 2 | 2 | 2 | 2 | | |
| | | Aromatic skeleton acid anhydride | | | | | | | 2 | |
| | | Polyalicyclic skeleton acid anhydride | | | | | | | | 2 |
| | | Terpene skeleton acid anhydride | | | | | | | | |
| | | Biphenyl skeleton phenol resin | | | | | | | | |
| | | Allyl skeleton phenol resin | | | | | | | | |
| | | Triazine skeleton phenol resin | | | | | | | | |
| | | Melamine skeleton phenol resin | | | | | | | | |
| | | Isocyanurate-modified solid dispersed imidazole | 0.5 | 0.5 | 0.5 | 0.5 | 0.5 | 0.5 | 0.5 | 0.5 |
| | Spherical filler (D1) | Spherical alumina 2 (average particle size: 0.4 μm) | 10 | 10 | 10 | 10 | 10 | 10 | 10 | 10 |
| | | Spherical magnesium oxide | | | | | | | | |
| | | (average particle size: 0.1 μm) | | | | | | | | |
| | Spherical filler (D2) | Spherical alumina 3 (average particle size: 5 μm) | 40 | 40 | 40 | 40 | 40 | 40 | 40 | 40 |
| | | Spherical aluminum nitride 1 | | | | | | | | |
| | | (average particle size: 3.7 μm) | | | | | | | | |
| | Spherical filler (D3) | Spherical alumina 4 (average particle size: 20 μm) | 40 | 40 | 40 | 40 | 40 | 40 | 40 | 40 |
| | | Spherical aluminum nitride 2 | | | | | | | | |
| | | (average particle size: 30 μm) | | | | | | | | |
| | Filler (D) | Spherical alumina 5 (average particle size: 0.7 μm) | | | | | | | | |
| | other than fillers | | | | | | | | | |
| | (D1) to (D3) | | | | | | | | | |
| | Dispersing agent (F) | Acrylic dispersing agent | | | | | | | | |
| | | Polyether dispersing agent | | | | | | | | |
| | Dispersing agent | Nonionic dispersing agent | | | | | | | | |
| | other than dispersing | | | | | | | | | |
| | agent (F) | | | | | | | | | |
| | Granular rubber (E) | Core-shell type fine granular rubber | | | | | | | | |
| | | Fine granular silicon rubber | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |
| Ratio of polymer (A) (% by weight) *1 | | | 40 | 40 | 40 | 40 | 40 | 40 | 40 | 40 |
| Ratio of monomer (B) (% by weight) *1 | | | 20 | 20 | 20 | 20 | 20 | 20 | 20 | 20 |
| Ratio of spherical filler (D1) (% by volume) *2 | | | 11 | 11 | 11 | 11 | 11 | 11 | 11 | 11 |
| Ratio of spherical filler (D2) (% by volume) *2 | | | 44.5 | 44.5 | 44.5 | 44.5 | 44.5 | 39 | 44.5 | 44.5 |
| Ratio of spherical filler (D3) (% by volume) *2 | | | 44.5 | 44.5 | 44.5 | 44.5 | 44.5 | 50 | 44.5 | 44.5 |
| Total ratio of filler (D1), (D2), and (D3) (% by volume) *3 | | | 73.6 | 73.6 | 73.6 | 73.6 | 73.6 | 73.6 | 73.6 | 73.6 |
| Ratio of filler (D) (% by volume) *3 | | | 73.6 | 73.6 | 73.6 | 73.6 | 73.6 | 73.6 | 73.6 | 73.6 |
| Evaluations | Handleability | | ◯ | ◯ | ◯ | ◯ | ◯ | ◯ | ◯ | ◯ |
| | Glass transition temperature (° C.) | | 13 | 9 | 14 | 16 | 10 | 8 | 19 | 14 |
| | Thermal conductivity (W/m · K) | | 4 | 4.1 | 4.3 | 4.4 | 4.5 | 4.3 | 4.2 | 4.1 |
| | Peel strength (N/cm) | | 16 | 19 | 20 | 17 | 18 | 22 | 14 | 17 |
| | Dielectric breakdown voltage (kV/mm) | | 45 | 38 | 44 | 55 | 53 | 50 | 46 | 46 |
| | Solder heat resistance (288° C.) | | ◯ | ◯ | ⊚ | ⊚ | ⊚ | ⊚ | ⊚ | ⊚ |
| | Reaction ratio (%) | | 7 | 7 | 9 | 7 | 8 | 4 | 6 | 6 |
| | Cumulative volume % | (0.1 μm) | 0 | 0 | 0 | 0 | 0 | 0 | 0 | 0 |
| | of filler | (0.5 μm) | 3 | 4 | 3 | 4 | 3 | 3 | 3 | 4 |
| | | (2.0 μm) | 4 | 4 | 3 | 5 | 4 | 3 | 3 | 5 |
| | | (6.0 μm) | 36 | 35 | 37 | 40 | 37 | 36 | 38 | 35 |
| | | (10.0 μm) | 58 | 60 | 59 | 60 | 58 | 55 | 58 | 59 |
| | | (40.0 μm) | 95 | 95 | 94 | 95 | 95 | 96 | 96 | 95 |

*1 The ratio in 100% by weight of all the resin components in the insulating sheet
*2 The ratio in 100% by volume of the filler (D)
*3 The ratio in 100% by volume of the insulating sheet

TABLE 6

| | | | Examples | | | | | | | |
|---|---|---|---|---|---|---|---|---|---|---|
| | | | 35 | 36 | 37 | 38 | 39 | 40 | 41 | 42 |
| Components | Polymer (A) | Epoxy group-containing styrene resin | | | | | | | | |
| (parts by | | Bisphenol A phenoxy resin | 4 | 4 | 4 | 4 | 4 | 3.5 | 3.5 | 3.5 |
| weight) | | Highly heat-resistant phenoxy resin | | | | | | | | |
| | Polymer | Epoxy group-containing acryl resin 1 | | | | | | | | |
| | other than polymer (A) | | | | | | | | | |
| | Epoxy monomer (B1) | Bisphenol A liquid epoxy resin | 2 | 2 | 2 | 2 | 2 | 2 | 2 | 1.5 |
| | | Bisphenol F liquid epoxy resin | | | | | | | | |
| | | Trifunctional glycidyl diamine liquid epoxy resin | | | | | | | | |
| | | Fluorene skeleton epoxy resin | | | | | | | | |
| | | Naphthalene skeleton liquid epoxy resin | | | | | | | | |
| | Oxetane monomer (B2) | Benzene skeleton oxetane resin | | | | | | | | |
| | Monomer | Hexahydro phthalate skeleton liquid epoxy resin | 0.5 | 0.5 | 0.5 | 0.5 | 0.5 | 0.5 | 0.5 | 0.5 |
| | other than monomer (B) | Bisphenol A solid epoxy resin | | | | | | | | |
| | Curing agent (C) | Alicyclic skeleton acid anhydride | | | | | | 2 | 2 | 2 |
| | | Aromatic skeleton acid anhydride | | | | | | | | |
| | | Polyalicyclic skeleton acid anhydride | | | | | | | | |
| | | Terpene skeleton acid anhydride | 2 | | | | | | | |
| | | Biphenyl skeleton phenol resin | | 2 | | | | | | |
| | | Allyl skeleton phenol resin | | | 2 | | | | | |
| | | Triazine skeleton phenol resin | | | | 2 | | | | |
| | | Melamine skeleton phenol resin | | | | | 2 | | | |
| | | Isocyanurate-modified solid dispersed imidazole | 0.5 | 0.5 | 0.5 | 0.5 | 0.5 | 0.5 | 0.5 | 0.5 |
| | Spherical filler (D1) | Spherical alumina 2 (average particle size: 0.4 μm) | 10 | 10 | 10 | 10 | 10 | 10 | 10 | 10 |
| | | Spherical magnesium oxide (average | | | | | | | | |
| | | particle size: 0.1 μm) | | | | | | | | |
| | Spherical filler (D2) | Spherical alumina 3 (average particle size: 5 μm) | 40 | 40 | 40 | 40 | 40 | 40 | 40 | 40 |
| | | Spherical aluminum nitride 1 (average | | | | | | | | |
| | | particle size: 3.7 μm) | | | | | | | | |
| | Spherical filler (D3) | Spherical alumina 4 (average particle size: 20 μm) | 40 | 40 | 40 | 40 | 40 | 40 | 40 | 40 |
| | | Spherical aluminum nitride 2 (average | | | | | | | | |
| | | particle size: 30 μm) | | | | | | | | |
| | Filler (D) | Spherical alumina 5 (average particle size: 0.7 μm) | | | | | | | | |
| | other than fillers (D1) | | | | | | | | | |
| | to (D3) | | | | | | | | | |
| | Dispersing agent (F) | Acrylic dispersing agent | | | | | | | | 1 |
| | | Polyether dispersing agent | | | | | | | | |
| | Dispersing agent | Nonionic dispersing agent | | | | | | | | |
| | other than dispersing | | | | | | | | | |
| | agent (F) | | | | | | | | | |
| | Granular rubber (E) | Core-shell type fine granular rubber | | | | | | 0.5 | | |
| | | Fine granular silicon rubber | | | | | | | 0.5 | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |
| Ratio of polymer (A) (% by weight) *1 | | | 40 | 40 | 40 | 40 | 40 | 35 | 35 | 39 |
| Ratio of monomer (B) (% by weight) *1 | | | 20 | 20 | 20 | 20 | 20 | 20 | 20 | 17 |
| Ratio of spherical filler (D1) (% by volume) *2 | | | 11 | 11 | 11 | 11 | 11 | 11 | 11 | 11 |
| Ratio of spherical filler (D2) (% by volume) *2 | | | 44.5 | 44.5 | 44.5 | 44.5 | 44.5 | 44.5 | 44.5 | 44.5 |
| Ratio of spherical filler (D3) (% by volume) *2 | | | 44.5 | 44.5 | 44.5 | 44.5 | 44.5 | 44.5 | 44.5 | 44.5 |
| Total ratio of fillers (D1), (D2), and (D3) (% by volume) *3 | | | 73.6 | 73.6 | 73.6 | 73.6 | 73.6 | 73.6 | 73.6 | 73.6 |
| Ratio of filler (D) (% by volume)*3 | | | 73.6 | 73.6 | 73.6 | 73.6 | 73.6 | 73.6 | 73.6 | 73.6 |
| Evaluations | Handleability | | ◯ | ◯ | ◯ | ◯ | ◯ | ◯ | ◯ | ◯ |
| | Glass transition temperature (° C.) | | 11 | 21 | 8 | 13 | 14 | 13 | 13 | 13 |
| | Thermal conductivity (W/m · K) | | 4.1 | 4.2 | 4.3 | 4.2 | 4.1 | 3.9 | 4 | 5.1 |
| | Peel strength (N/cm) | | 19 | 15 | 18 | 20 | 19 | 16 | 16 | 17 |
| | Dielectric breakdown voltage (kV/mm) | | 45 | 52 | 53 | 50 | 51 | 44 | 41 | 71 |
| | Solder heat resistance (288° C.) | | ⊚ | ⊚ | ⊚ | ⊚ | ⊚ | ⊚ | ⊚ | ⊚ |
| | Reaction ratio (%) | | 5 | 8 | 8 | 6 | 7 | 6 | 6 | 8 |
| | Cumulative volume % | (0.1 μm) | 0 | 0 | 0 | 0 | 0 | 0 | 0 | 0 |
| | of filler | (0.5 μm) | 4 | 3 | 3 | 3 | 4 | 3 | 4 | 3 |
| | | (2.0 μm) | 4 | 4 | 3 | 3 | 4 | 4 | 4 | 4 |
| | | (6.0 μm) | 37 | 37 | 36 | 35 | 38 | 40 | 38 | 35 |
| | | (10.0 μm) | 57 | 58 | 61 | 63 | 58 | 58 | 59 | 60 |
| | | (40.0 μm) | 96 | 96 | 95 | 95 | 95 | 95 | 95 | 95 |

*1 The ratio in 100% by weight of all the resin components in the insulating sheet
*2 The ratio in 100% by volume of the filler (D)
*3 The ratio in 100% by volume of the insulating sheet

TABLE 7

| | | | Examples | | Comparative Examples | | | | |
|---|---|---|---|---|---|---|---|---|---|
| | | | 43 | 44 | 4 | 5 | 6 | 7 | 8 |
| Components | Polymer (A) | Epoxy group-containing styrene resin | | | | | | | |
| (parts by weight) | | Bisphenol A phenoxy resin | 3.5 | 3.5 | 4 | 4 | 4 | | 4 |
| | | Highly heat-resistant phenoxy resin | | | | | | | |
| | Polymer | Epoxy group-containing acryl resin 1 | | | | | | 4 | |
| | other than polymer (A) | | | | | | | | |
| | Epoxy monomer (B1) | Bisphenol A liquid epoxy resin | 1.5 | 1.5 | 2 | 2 | 2 | 2 | |
| | | Bisphenol F liquid epoxy resin | | | | | | | |
| | | Trifunctional glycidyl diamine liquid epoxy resin | | | | | | | |
| | | Fluorene skeleton epoxy resin | | | | | | | |
| | | Naphthalene skeleton liquid epoxy resin | | | | | | | |
| | Oxetane monomer (B2) | Benzene skeleton oxetane resin | | | | | | | |
| | Monomer | Hexahydro phthalate skeleton liquid epoxy resin | 0.5 | 0.5 | 0.5 | 0.5 | 0.5 | 0.5 | 0.5 |
| | other than monomer (B) | Bisphenol A solid epoxy resin | | | | | | | 2 |
| | Curing agent (C) | Alicyclic skeleton acid anhydride | 2 | 2 | 2 | 2 | 2 | 2 | 2 |
| | | Aromatic skeleton acid anhydride | | | | | | | |
| | | Polyalicyclic skeleton acid anhydride | | | | | | | |
| | | Terpene skeleton acid anhydride | | | | | | | |
| | | Biphenyl skeleton phenol resin | | | | | | | |
| | | Allyl skeleton phenol resin | | | | | | | |
| | | Triazine skeleton phenol resin | | | | | | | |
| | | Melamine skeleton phenol resin | | | | | | | |
| | | Isocyanurate-modified solid dispersed imidazole | 0.5 | 0.5 | 0.5 | 0.5 | 0.5 | 0.5 | 0.5 |
| | Spherical filler (D1) | Spherical alumina 2 (average particle | 10 | 10 | | | 10 | 10 | 10 |
| | | size: 0.4 μm) | | | | | | | |
| | | Spherical magnesium oxide (average | | | | | | | |
| | | particle size: 0.1 μm) | | | | | | | |
| | Spherical filler (D2) | Spherical alumina 3 (average particle size: 5 μm) | 40 | 40 | 40 | 40 | 10 | 40 | 40 |
| | | Spherical aluminum nitride 1 (average | | | | | | | |
| | | particle size: 3.7 μm) | | | | | | | |
| | Spherical filler (D3) | Spherical alumina 4 (average particle size: 20 μm) | 40 | 40 | 50 | 40 | 70 | 40 | 40 |
| | | Spherical aluminum nitride 2 (average | | | | | | | |
| | | particle size: 30 μm) | | | | | | | |
| | Filler (D) | Spherical alumina 5 (average particle | | | | 10 | | | |
| | other than fillers (D1) to (D3) | size: 0.7 μm) | | | | | | | |
| | Dispersing agent (F) | Acrylic dispersing agent | | | | | | | |
| | | Polyether dispersing agent | 1 | | | | | | |
| | Dispersing agent | Nonionic dispersing agent | | 1 | | | | | |
| | other than dispersing agent (F) | | | | | | | | |
| | Granular rubber (E) | Core-shell type fine granular rubber | | | | | | | |
| | | Fine granular silicon rubber | | | | | | | |
| | Additive | Epoxy silane coupling agent | 1 | 1 | 1 | 1 | 1 | 1 | 1 |
| | Solvent | Methylethyl ketone | 20 | 20 | 20 | 20 | 20 | 20 | 20 |

| Ratio of polymer (A) (% by weight) *1 | | | 39 | 39 | 40 | 40 | 40 | 40 | 40 |
|---|---|---|---|---|---|---|---|---|---|
| Ratio of monomer (B) (% by weight) *1 | | | 17 | 17 | 20 | 20 | 20 | 20 | — |
| Ratio of spherical filler (D1) (% by volume) *2 | | | 11 | 11 | — | — | 11 | 11 | 11 |
| Ratio of spherical filler (D2) (% by volume) *2 | | | 44.5 | 44.5 | 45 | 44.5 | 11 | 39 | 39 |
| Ratio of spherical filler (D3) (% by volume) *2 | | | 44.5 | 44.5 | 55 | 44.5 | 78 | 50 | 50 |
| Total ratio of fillers (D1), (D2), and (D3) (% by volume) *3 | | | 73.6 | 73.6 | 73.6 | 65.5 | 73.6 | 73.6 | 73.6 |
| Ratio of filler (D) (% by volume) *3 | | | 73.6 | 73.6 | 73.6 | 73.6 | 73.6 | 73.6 | 73.6 |
| Evaluations | Handleability | | ◯ | ◯ | ◯ | ◯ | ◯ | X | Δ |
| | Glass transition temperature (° C.) | | 13 | 13 | 14 | 13 | 15 | 2 | 34 |
| | Thermal conductivity (W/m · K) | | 5.1 | 4.3 | 4.5 | 4.7 | 4.4 | — | 3.9 |
| | Peel strength (N/cm) | | 17 | 17 | 10 | 12 | 9 | — | 10 |
| | Dielectric breakdown voltage (kV/mm) | | 70 | 50 | 12 | 13 | 9 | — | 42 |
| | Solder heat resistance (288° C.) | | ⊚ | ⊚ | ⊚ | ⊚ | ⊚ | — | ⊚ |
| | Reaction ratio (%) | | 7 | 7 | 6 | 6 | 6 | 8 | 13 |
| | Cumulative volume % of filler | (0.1 μm) | 0 | 0 | 0 | 0 | 0 | 0 | 0 |
| | | (0.5 μm) | 3 | 3 | 0 | 1 | 3 | 3 | 3 |
| | | (2.0 μm) | 4 | 4 | 1 | 8 | 3 | 4 | 4 |
| | | (6.0 μm) | 35 | 35 | 30 | 40 | 10 | 37 | 36 |
| | | (10.0 μm) | 60 | 60 | 60 | 61 | 29 | 58 | 57 |
| | | (40.0 μm) | 95 | 95 | 78 | 98 | 68 | 95 | 97 |

*1 The ratio in 100% by weight of all the resin components in the insulating sheet
*2 The ratio in 100% by volume of the filler (D)
*3 The ratio in 100% by volume of the insulating sheet

### Examples 45 to 62 and Comparative Examples 9 to 13

Except that the types and amounts of the compounds were changed as shown in the following Tables 8 to 10, insulating materials were prepared in the same manner as in Example 1 and insulating sheets each were prepared on the PET film.

### Evaluations on Insulating Sheets of Examples 45 to 62 and Comparative Examples 9 to 13

The insulating sheet was evaluated for the aforementioned evaluation items (1) handleability, (2) glass transition temperature, (3) thermal conductivity, (4) peel strength, (5) dielectric breakdown voltage, (6) solder heat resistance, and (7) reaction ratio. Further, the insulating sheet was evaluated for the following evaluation item (9) self supportability.

### (9) Self Supportability

In the evaluation of the evaluation item (1) handleability, the uncured insulating sheet after peeled off from the PET sheet was prepared. Each of the four corners of this uncured insulating sheet was fixed, and thus the insulating sheet was hung in midair so that the four corners were parallel to the horizontal direction. The insulating sheet was left for 10 minutes at 23° C., and the deformation of the insulating sheet was observed. The self supportability was evaluated according to the following criteria.

### [Evaluation Criteria of Self Supportability]

o: The insulating sheet sagged downward and the sagging length (the degree of deformation) of the insulating sheet in the vertical direction was 5 cm or shorter.

Δ: The insulating sheet sagged downward and the sagging length (the degree of deformation) of the insulating sheet in the vertical direction was longer than 5 cm.

x: The insulating sheet tore.

Tables 8 to 10 show the results.

TABLE 8

| | | | Examples | | | | | | | |
|---|---|---|---|---|---|---|---|---|---|---|
| | | | 45 | 46 | 47 | 48 | 49 | 50 | 51 | 52 |
| Components | Polymer (A) | Epoxy group-containing styrene resin | | | | | | 9 | | |
| (parts by weight) | | Bisphenol A phenoxy resin | 9 | 9 | 9 | 9 | | | 9 | 9 |
| | | Highly heat-resistant phenoxy resin | | | | | 9 | | | |
| | Polymer | Epoxy group-containing acryl resin 1 | | | | | | | | |
| | other than polymer (A) | | | | | | | | | |
| | Epoxy monomer (B1) | Bisphenol A liquid epoxy resin | 4 | 4 | 4 | 4 | 4 | 4 | | |
| | | Bisphenol F liquid epoxy resin | | | | | | | 4 | |
| | | Trifunctional glycidyl diamine liquid epoxy resin | | | | | | | | 4 |
| | | Fluorene skeleton epoxy resin | | | | | | | | |
| | | Naphthalene skeleton liquid epoxy resin | | | | | | | | |
| | Oxetane monomer | Benzene skeleton oxetane resin | | | | | | | | |
| | (B2) | | | | | | | | | |
| | Monomer other | Hexahydro phthalate skeleton liquid epoxy resin | 2 | 2 | 2 | 2 | 2 | 2 | 2 | 2 |
| | than monomer (B) | Bisphenol A solid epoxy resin | | | | | | | | |
| | Curing agent (C) | Alicyclic skeleton acid anhydride | 2 | 2 | 2 | 2 | 2 | 2 | 2 | 2 |
| | | Aromatic skeleton acid anhydride | | | | | | | | |
| | | Polyalicyclic skeleton acid anhydride | | | | | | | | |
| | | Terpene skeleton acid anhydride | | | | | | | | |
| | | Biphenyl skeleton phenol resin | | | | | | | | |
| | | Allyl skeleton phenol resin | | | | | | | | |
| | | Triazine skeleton phenol resin | | | | | | | | |
| | | Melamine skeleton phenol resin | | | | | | | | |
| | | Isocyanurate-modified solid dispersed imidazole | 1 | 1 | 1 | 1 | 1 | 1 | 1 | 1 |
| | Crushed filler (D4) | 5-μm Alumina | 80 | | | 80 | 80 | 80 | 80 | 80 |
| | | 2-μm Alumina | | 80 | | | | | | |
| | | 1.2-μm Aluminum nitride | | | 62 | | | | | |
| | Filler (D) | 29-μm Alumina | | | | | | | | |
| | other than crushed | | | | | | | | | |
| | filler (D4) | | | | | | | | | |
| | Dispersing agent (F) | Acrylic dispersing agent | 1 | 1 | 1 | | 1 | 1 | 1 | 1 |
| | | Polyether dispersing agent | | | | 1 | | | | |
| | Dispersing agent | Nonionic dispersing agent | | | | | | | | |
| | other than dispersing | | | | | | | | | |
| | agent (F) | | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |

| Ratio of polymer (A) (% by weight) *1 | | 47 | 47 | 47 | 47 | 47 | 47 | 47 | 47 |
|---|---|---|---|---|---|---|---|---|---|
| Ratio of monomer (B) (% by weight) *1 | | 21 | 21 | 21 | 21 | 21 | 21 | 21 | 21 |
| Ratio of spherical filler (D) (% by volume) *2 | | 56 | 56 | 56 | 56 | 56 | 56 | 56 | 56 |
| Ratio of dispersing agent (F) (% by weight) *3 | | 1 | 1 | 1 | 1 | 1 | 1 | 1 | 1 |
| Evaluations | Handleability | ◯ | ◯ | ◯ | ◯ | ◯ | ◯ | ◯ | ◯ |
| | Self supportability | ◯ | ◯ | ◯ | ◯ | ◯ | ◯ | ◯ | ◯ |
| | Glass transition temperature (° C.) | 8 | 9 | 10 | 7 | 13 | 13 | 6 | 14 |
| | Thermal conductivity (W/m · K) | 2.4 | 2.6 | 2.5 | 2.4 | 2.5 | 2.4 | 2.4 | 2.5 |
| | Peel strength (N/cm) | 15 | 15 | 14 | 16 | 17 | 14 | 15 | 16 |
| | Dielectric breakdown voltage (kV/mm) | 81 | 80 | 85 | 81 | 85 | 78 | 71 | 70 |
| | Solder heat resistance (288° C.) | ◯ | ◯ | ◯ | ◯ | ◯ | ◯ | ◯ | ◯ |
| | Reaction ratio (%) | 8 | 8 | 9 | 7 | 8 | 9 | 8 | 9 |

*1 The ratio in 100% by weight of all the resin components in the insulating sheet
*2 The ratio in 100% by volume of the insulating sheet
*3 The ratio in 100% by weight of the insulating sheet

TABLE 9

| | | | Examples | | | | | | | |
|---|---|---|---|---|---|---|---|---|---|---|
| | | | 53 | 54 | 55 | 56 | 57 | 58 | 59 | 60 |
| Components | Polymer (A) | Epoxy group-containing styrene resin | | | | | | | | |
| (parts by weight) | | Bisphenol A phenoxy resin | 9 | 9 | 9 | 9 | 9 | 9 | 9 | 9 |
| | | Highly heat-resistant phenoxy resin | | | | | | | | |
| | Polymer | Epoxy group-containing acryl resin 1 | | | | | | | | |
| | other than polymer (A) | | | | | | | | | |
| | Epoxy monomer (B1) | Bisphenol A liquid epoxy resin | | | | 4 | 4 | 4 | 4 | 4 |
| | | Bisphenol F liquid epoxy resin | | | | | | | | |
| | | Trifunctional glycidyl diamine liquid epoxy resin | | | | | | | | |
| | | Fluorene skeleton epoxy resin | 4 | | | | | | | |
| | | Naphthalene skeleton liquid epoxy resin | | 4 | | | | | | |
| | Oxetane monomer | Benzene skeleton oxetane resin | | | 4 | | | | | |
| | (B2) | | | | | | | | | |
| | Monomer other | Hexahydro phthalate skeleton liquid epoxy resin | 2 | 2 | 2 | 2 | 2 | 2 | 2 | 2 |
| | than monomer (B) | Bisphenol A solid epoxy resin | | | | | | | | |
| | Curing agent (C) | Alicyclic skeleton acid anhydride | 2 | 2 | 2 | | | | | |
| | | Aromatic skeleton acid anhydride | | | | 2 | | | | |
| | | Polyalicyclic skeleton acid anhydride | | | | | 2 | | | |
| | | Terpene skeleton acid anhydride | | | | | | 2 | | |
| | | Biphenyl skeleton phenol resin | | | | | | | 2 | |
| | | Allyl skeleton phenol resin | | | | | | | | 2 |
| | | Triazine skeleton phenol resin | | | | | | | | |
| | | Melamine skeleton phenol resin | | | | | | | | |
| | | Isocyanurate-modified solid dispersed imidazole | 1 | 1 | 1 | 1 | 1 | 1 | 1 | 1 |
| | Crushed filler (D4) | 5-μm Alumina | 80 | 80 | 80 | 80 | 80 | 80 | 80 | 80 |
| | | 2-μm Alumina | | | | | | | | |
| | | 1.2-μm Aluminum nitride | | | | | | | | |
| | Filler (D) | 29-μm Alumina | | | | | | | | |
| | other than crushed | | | | | | | | | |
| | filler (D4) | | | | | | | | | |
| | Dispersing agent (F) | Acrylic dispersing agent | 1 | 1 | 1 | 1 | 1 | 1 | 1 | 1 |
| | | Polyether dispersing agent | | | | | | | | |
| | Dispersing agent | Nonionic dispersing agent | | | | | | | | |
| | other than dispersing | | | | | | | | | |
| | agent (F) | | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |

| Ratio of polymer (A) (% by weight) *1 | | 47 | 47 | 47 | 47 | 47 | 47 | 47 | 47 |
|---|---|---|---|---|---|---|---|---|---|
| Ratio of monomer (B) (% by weight) *1 | | 21 | 21 | 21 | 21 | 21 | 21 | 21 | 21 |
| Ratio of spherical filler (D) (% by volume) *2 | | 56 | 56 | 56 | 56 | 56 | 56 | 56 | 56 |
| Ratio of dispersing agent (F) (% by weight) *3 | | 1 | 1 | 1 | 1 | 1 | 1 | 1 | 1 |
| Evaluations | Handleability | ◯ | ◯ | ◯ | ◯ | ◯ | ◯ | ◯ | ◯ |
| | Self supportability | ◯ | ◯ | ◯ | ◯ | ◯ | ◯ | ◯ | ◯ |
| | Glass transition temperature (° C.) | 16 | 11 | 12 | 19 | 15 | 11 | 22 | 10 |
| | Thermal conductivity (W/m · K) | 2.4 | 2.5 | 2.5 | 2.2 | 2.4 | 2.4 | 2.2 | 2.1 |
| | Peel strength (N/cm) | 14 | 15 | 18 | 14 | 16 | 17 | 15 | 15 |
| | Dielectric breakdown voltage (kV/mm) | 82 | 83 | 85 | 78 | 83 | 85 | 88 | 81 |
| | Solder heat resistance (288° C.) | ◯ | ◯ | ◯ | ◯ | ◯ | ◯ | ◯ | ◯ |
| | Reaction ratio (%) | 9 | 8 | 6 | 7 | 6 | 6 | 8 | 9 |

*1 The ratio in 100% by weight of all the resin components in the insulating sheet
*2 The ratio in 100% by volume of the insulating sheet
*3 The ratio in 100% by weight of the insulating sheet

TABLE 10

| | | | Examples | | Comparative Examples | | | | |
|---|---|---|---|---|---|---|---|---|---|
| | | | 61 | 62 | 9 | 10 | 11 | 12 | 13 |
| Components | Polymer (A) | Epoxy group-containing styrene resin | | | | | | | |
| (parts by weight) | | Bisphenol A phenoxy resin | 9 | 9 | 10 | 9 | 9 | | 9 |
| | | Highly heat-resistant phenoxy resin | | | | | | | |
| | Polymer | Epoxy group-containing acryl resin 1 | | | | | | 9 | |
| | other than polymer (A) | | | | | | | | |
| | Epoxy monomer (B1) | Bisphenol A liquid epoxy resin | 4 | 4 | 4 | 4 | 4 | 4 | |
| | | Bisphenol F liquid epoxy resin | | | | | | | |
| | | Trifunctional glycidyl diamine liquid epoxy resin | | | | | | | |
| | | Fluorene skeleton epoxy resin | | | | | | | |
| | | Naphthalene skeleton liquid epoxy resin | | | | | | | |
| | Oxetane monomer | Benzene skeleton oxetane resin | | | | | | | |
| | (B2) | | | | | | | | |
| | Monomer other | Hexahydro phthalate skeleton liquid epoxy resin | 2 | 2 | 2 | 2 | 2 | 2 | 2 |
| | than monomer (B) | Bisphenol A solid epoxy resin | | | | | | | 4 |
| | Curing agent (C) | Alicyclic skeleton acid anhydride | | | 2 | 2 | 2 | 2 | 2 |
| | | Aromatic skeleton acid anhydride | | | | | | | |
| | | Polyalicyclic skeleton acid anhydride | | | | | | | |
| | | Terpene skeleton acid anhydride | | | | | | | |
| | | Biphenyl skeleton phenol resin | | | | | | | |
| | | Allyl skeleton phenol resin | | | | | | | |
| | | Triazine skeleton phenol resin | 2 | | | | | | |
| | | Melamine skeleton phenol resin | | 2 | | | | | |
| | | Isocyanurate-modified solid dispersed imidazole | 1 | 1 | 1 | 1 | 1 | 1 | 1 |
| | Crushed filler (D4) | 5-μm Alumina | 80 | 80 | 80 | 80 | | 80 | 80 |
| | | 2-μm Alumina | | | | | | | |
| | | 1.2-μm Aluminum nitride | | | | | | | |
| | Filler (D) | 29-μm Alumina | | | | | 80 | | |
| | other than crushed | | | | | | | | |
| | filler (D4) | | | | | | | | |
| | Dispersing agent (F) | Acrylic dispersing agent | 1 | 1 | | | 1 | 1 | 1 |
| | | Polyether dispersing agent | | | | | | | |
| | Dispersing agent | Nonionic dispersing agent | | | | 1 | | | |
| | other than dispersing | | | | | | | | |
| | agent (F) | | | | | | | | |
| | Additive | Epoxy silane coupling agent | 1 | 1 | 1 | 1 | 1 | 1 | 1 |
| | Solvent | Methylethyl ketone | 20 | 20 | 20 | 20 | 20 | 20 | 20 |

| Ratio of polymer (A) (% by weight) *1 | | 47 | 47 | 50 | 47 | 47 | — | 47 |
|---|---|---|---|---|---|---|---|---|
| Ratio of monomer (B) (% by weight) *1 | | 21 | 21 | 20 | 21 | 21 | 21 | — |
| Ratio of spherical filler (D) (% by volume) *2 | | 56 | 56 | 56 | 56 | 56 | 56 | 56 |
| Ratio of dispersing agent (F) (% by weight) *3 | | 1 | 1 | 0 | 0 | 1 | 1 | 1 |
| Evaluations | Handleability | ◯ | ◯ | X | X | X | X | X |
| | Self supportability | ◯ | ◯ | X | X | X | — | — |
| | Glass transition temperature (° C.) | 12 | 15 | 9 | 8 | 8 | 6 | 35 |
| | Thermal conductivity (W/m · K) | 2.3 | 2.4 | 0.9 | 1.1 | 1.1 | — | — |
| | Peel strength (N/cm) | 15 | 15 | 6 | 7 | 13 | 20 | 8 |
| | Dielectric breakdown voltage (kV/mm) | 84 | 85 | 10 | 15 | 11 | — | — |
| | Solder heat resistance (288° C.) | ◯ | ◯ | ◯ | ◯ | ◯ | ◯ | ◯ |
| | Reaction ratio (%) | 8 | 8 | 8 | 8 | 8 | 8 | 14 |

*1 The ratio in 100% by weight of all the resin components in the insulating sheet
*2 The ratio in 100% by volume of the insulating sheet
*3 The ratio in 100% by weight of the insulating sheet

### Examples 63 to 81 and Comparative Examples 14 to 16

Except that the types and amounts of the compounds were changed as shown in the following Tables 11 to 13, insulating materials were prepared in the same manner as in Example 1 and insulating sheets each were prepared on the PET film.

### Evaluations on Insulating Sheets of Examples 63 to 81 and Comparative Examples 14 to 16

The insulating sheet was evaluated for the aforementioned evaluation items (1) handleability, (9) self supportability, (2) glass transition temperature, (3) thermal conductivity, (4) peel strength, (5) dielectric breakdown voltage, (6) solder heat resistance, and (7) reaction ratio.

Tables 8 to 10 show the results.

TABLE 11

| | | | Examples | | | | | | | |
|---|---|---|---|---|---|---|---|---|---|---|
| | | | 63 | 64 | 65 | 66 | 67 | 68 | 69 | 70 |
| Components | Polymer (A) | Epoxy group-containing styrene resin | 10 | | | | | | | |
| (parts by weight) | | Bisphenol A phenoxy resin | | 10 | | | | | | |
| | | Highly heat-resistant phenoxy resin | | | 10 | 10 | 10 | 10 | 10 | 10 |
| | Polymer | Acrylonitrile-butadiene rubber | | | | | | | | |
| | other than polymer (A) | Epoxy group-containing acryl resin 2 | | | | | | | | |
| | Epoxy monomer (B1) | Bisphenol A liquid epoxy resin | 3 | 3 | 3 | | | | | |
| | | Bisphenol F liquid epoxy resin | | | | 3 | | | | |
| | | Trifunctional glycidyl diamine liquid epoxy resin | | | | | 3 | | | |
| | | Fluorene skeleton epoxy resin | | | | | | 3 | | |
| | | Naphthalene skeleton liquid epoxy resin | | | | | | | 3 | |
| | Oxetane monomer (B2) | Benzene skeleton oxetane resin | | | | | | | | 3 |
| | Monomer | Hexahydro phthalate skeleton liquid epoxy resin | 2 | 2 | 2 | 2 | 2 | 2 | 2 | 2 |
| | other than monomer (B) | Bisphenol A solid epoxy resin | | | | | | | | |
| | Curing agent (C) | Alicyclic skeleton acid anhydride | 2 | 2 | 2 | 2 | 2 | 2 | 2 | 2 |
| | | Aromatic skeleton acid anhydride | | | | | | | | |
| | | Polyalicyclic skeleton acid anhydride | | | | | | | | |
| | | Terpene skeleton acid anhydride | | | | | | | | |
| | | Biphenyl skeleton phenol resin | | | | | | | | |
| | | Allyl skeleton phenol resin | | | | | | | | |
| | | Triazine skeleton phenol resin | | | | | | | | |
| | | Melamine skeleton phenol resin | | | | | | | | |
| | | Isocyanurate-modified solid dispersed imidazole | 1 | 1 | 1 | 1 | 1 | 1 | 1 | 1 |
| | Filler (D) | Surface-hydrophobic fumed silica | 1 | 1 | 1 | 1 | 1 | 1 | 1 | 1 |
| | | Spherical alumina 1 | 80 | 80 | 80 | 80 | 80 | 80 | 80 | 80 |
| | | Boron nitride | | | | | | | | |
| | | Aluminum nitride | | | | | | | | |
| | Granular rubber (E) | Core-shell type fine granular rubber | | | | | | | | |
| | | Fine granular silicon rubber | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |

| Ratio of polymer (A) (% by weight) *1 | | 53 | 53 | 53 | 53 | 53 | 53 | 53 | 53 |
|---|---|---|---|---|---|---|---|---|---|
| Ratio of monomer (B) (% by weight) *1 | | 16 | 16 | 16 | 16 | 16 | 16 | 16 | 16 |
| Ratio of filler (D) (% by volume) *2 | | 57 | 57 | 57 | 57 | 57 | 57 | 57 | 57 |
| Evaluations | Handleability | ◯ | ◯ | ◯ | ◯ | ◯ | ◯ | ◯ | ◯ |
| | Self supportability | ◯ | ◯ | ◯ | ◯ | ◯ | ◯ | ◯ | ◯ |
| | Glass transition temperature (° C.) | 14 | 9 | 12 | 9 | 13 | 14 | 11 | 8 |
| | Thermal conductivity (W/m · K) | 2 | 2.2 | 2.4 | 2.3 | 2.3 | 2.4 | 2.3 | 2.4 |
| | Peel strength (N/cm) | 15 | 17 | 19 | 20 | 19 | 18 | 19 | 23 |
| | Dielectric breakdown voltage (kV/mm) | 42 | 46 | 60 | 55 | 61 | 66 | 70 | 62 |
| | Solder heat resistance (288° C.) | ◯ | ◯ | ◯ | ◯ | ◯ | ◯ | ◯ | ◯ |
| | Reaction ratio (%) | 8 | 6 | 5 | 6 | 7 | 7 | 6 | 4 |

*1 The ratio in 100% by weight of all the resin components in the insulating sheet
*2 The ratio in 100% by volume of the insulating sheet

TABLE 12

| | | | Examples | | | | | | | |
|---|---|---|---|---|---|---|---|---|---|---|
| | | | 71 | 72 | 73 | 74 | 75 | 76 | 77 | 78 |
| Components | Polymer (A) | Epoxy group-containing styrene resin | | | | | | | | |
| (parts by weight) | | Bisphenol A phenoxy resin | | | | | | | | |
| | | Highly heat-resistant phenoxy resin | 10 | 10 | 10 | 10 | 10 | 10 | 10 | 20 |
| | Polymer | Acrylonitrile-butadiene rubber | | | | | | | | |
| | other than polymer (A) | Epoxy group-containing acryl resin 2 | | | | | | | | |
| | Epoxy monomer (B1) | Bisphenol A liquid epoxy resin | 3 | 3 | 3 | 3 | 3 | 3 | 3 | 8 |
| | | Bisphenol F liquid epoxy resin | | | | | | | | |
| | | Trifunctional glycidyl diamine liquid epoxy resin | | | | | | | | |
| | | Fluorene skeleton epoxy resin | | | | | | | | |
| | | Naphthalene skeleton liquid epoxy resin | | | | | | | | |
| | Oxetane monomer (B2) | Benzene skeleton oxetane resin | | | | | | | | |
| | Monomer | Hexahydro phthalate skeleton liquid epoxy resin | 2 | 2 | 2 | 2 | 2 | 2 | 2 | 2 |
| | other than monomer (B) | Bisphenol A solid epoxy resin | | | | | | | | |
| | Curing agent (C) | Alicyclic skeleton acid anhydride | | | | | | | | 6 |
| | | Aromatic skeleton acid anhydride | 2 | | | | | | | |
| | | Polyalicyclic skeleton acid anhydride | | 2 | | | | | | |
| | | Terpene skeleton acid anhydride | | | 2 | | | | | |
| | | Biphenyl skeleton phenol resin | | | | 2 | | | | |
| | | Allyl skeleton phenol resin | | | | | 2 | | | |
| | | Triazine skeleton phenol resin | | | | | | 2 | | |
| | | Melamine skeleton phenol resin | | | | | | | 2 | |
| | | Isocyanurate-modified solid dispersed imidazole | 1 | 1 | 1 | 1 | 1 | 1 | 1 | 2 |
| | Filler (D) | Surface-hydrophobic fumed silica | 1 | 1 | 1 | 1 | 1 | 1 | 1 | 1 |
| | | Spherical alumina 1 | 80 | 80 | 80 | 80 | 80 | 80 | 80 | |
| | | Boron nitride | | | | | | | | 60 |
| | | Aluminum nitride | | | | | | | | |
| | Granular rubber (E) | Core-shell type fine granular rubber | | | | | | | | |
| | | Fine granular silicon rubber | | | | | | | | |
| | Additive | Epoxy silane coupling agent | 1 | 1 | 1 | 1 | 1 | 1 | 1 | 1 |
| | Solvent | Methylethyl ketone | 20 | 20 | 20 | 20 | 20 | 20 | 20 | 20 |

| Ratio of polymer (A) (% by weight) *1 | | 53 | 53 | 53 | 53 | 53 | 53 | 53 | 51 |
|---|---|---|---|---|---|---|---|---|---|
| Ratio of monomer (B) (% by weight) *1 | | 16 | 16 | 16 | 16 | 16 | 16 | 16 | 21 |
| Ratio of filler (D) (% by volume) *2 | | 57 | 57 | 57 | 57 | 57 | 57 | 57 | 32 |
| Evaluations | Handleability | ◯ | ◯ | ◯ | ◯ | ◯ | ◯ | ◯ | ◯ |
| | Self supportability | ◯ | ◯ | ◯ | ◯ | ◯ | ◯ | ◯ | ◯ |
| | Glass transition temperature (° C.) | 20 | 7 | 8 | 19 | 12 | 15 | 11 | 13 |
| | Thermal conductivity (W/m · K) | 2.1 | 2.4 | 2.4 | 2 | 2.1 | 2.2 | 2.4 | 3.4 |
| | Peel strength (N/cm) | 17 | 20 | 22 | 14 | 17 | 18 | 22 | 14 |
| | Dielectric breakdown voltage (kV/mm) | 60 | 64 | 65 | 62 | 57 | 59 | 63 | 42 |
| | Solder heat resistance (288° C.) | ◯ | ◯ | ◯ | ◯ | ◯ | ◯ | ◯ | ◯ |
| | Reaction ratio (%) | 6 | 8 | 5 | 8 | 9 | 7 | 7 | 6 |

*1 The ratio in 100% by weight of all the resin components in the insulating sheet
*2 The ratio in 100% by volume of the insulating sheet

TABLE 13

| | | | | | | Comparative | | |
|---|---|---|---|---|---|---|---|---|
| | | | Examples | | | Examples | | |
| | | | 79 | 80 | 81 | 14 | 15 | 16 |
| Components | Polymer (A) | Epoxy group-containing styrene resin | | | | | | |
| (parts by weight) | | Bisphenol A phenoxy resin | | | | | | |
| | | Highly heat-resistant phenoxy resin | 10 | 10 | 10 | | | 10 |
| | Polymer | Acrylonitrile-butadiene rubber | | | | 10 | | |
| | other than polymer (A) | Epoxy group-containing acryl resin 2 | | | | | 10 | |
| | Epoxy monomer (B1) | Bisphenol A liquid epoxy resin | 3 | 3 | 3 | 3 | 3 | |
| | | Bisphenol F liquid epoxy resin | | | | | | |
| | | Trifunctional glycidyl diamine liquid epoxy resin | | | | | | |
| | | Fluorene skeleton epoxy resin | | | | | | |
| | | Naphthalene skeleton liquid epoxy resin | | | | | | |
| | Oxetane monomer (B2) | Benzene skeleton oxetane resin | | | | | | |
| | Monomer | Hexahydro phthalate skeleton liquid epoxy resin | 2 | 1 | 1 | 2 | 2 | 2 |
| | other than monomer (B) | Bisphenol A solid epoxy resin | | | | | | 3 |
| | Curing agent (C) | Alicyclic skeleton acid anhydride | 2 | 2 | 2 | 2 | 2 | 2 |
| | | Aromatic skeleton acid anhydride | | | | | | |
| | | Polyalicyclic skeleton acid anhydride | | | | | | |
| | | Terpene skeleton acid anhydride | | | | | | |
| | | Biphenyl skeleton phenol resin | | | | | | |
| | | Allyl skeleton phenol resin | | | | | | |
| | | Triazine skeleton phenol resin | | | | | | |
| | | Melamine skeleton phenol resin | | | | | | |
| | | Isocyanurate-modified solid dispersed imidazole | 1 | 1 | 1 | 1 | 1 | 1 |
| | Filler (D) | Surface-hydrophobic fumed silica | 1 | 1 | 1 | 1 | 1 | 1 |
| | | Spherical alumina 1 | | 80 | 80 | 80 | 80 | 80 |
| | | Boron nitride | | | | | | |
| | | Aluminum nitride | 80 | | | | | |
| | Granular rubber (E) | Core-shell type fine granular rubber | | 1 | | | | |
| | | Fine granular silicon rubber | | | 1 | 1 | 1 | |
| | Additive | Epoxy silane coupling agent | 1 | 1 | 1 | 1 | 1 | 1 |
| | Solvent | Methylethyl ketone | 20 | 20 | 20 | 20 | 20 | 20 |

| Ratio of polymer (A) (% by weight) *1 | | 53 | 53 | 53 | 0 | 0 | 53 |
|---|---|---|---|---|---|---|---|
| Ratio of monomer (B) (% by weight) *1 | | 16 | 16 | 16 | 15 | 15 | 0 |
| Ratio of filler (D) (% by volume) *2 | | 57 | 57 | 57 | 57 | 57 | 57 |
| Evaluations | Handleability | ◯ | ◯ | ◯ | X | X | ◯ |
| | Self supportability | ◯ | ◯ | ◯ | X | X | ◯ |
| | Glass transition temperature (° C.) | 12 | 13 | 12 | −5 | 5 | 30 |
| | Thermal conductivity (W/m · K) | 4.2 | 2 | 2 | — | — | 2.1 |
| | Peel strength (N/cm) | 18 | 20 | 21 | — | — | 8 |
| | Dielectric breakdown voltage (kV/mm) | 53 | 60 | 58 | — | — | 52 |
| | Solder heat resistance (288° C.) | ◯ | ◯ | ◯ | — | — | ◯ |
| | Reaction ratio (%) | 7 | 6 | 6 | 7 | 8 | 14 |

*1 The ratio in 100% by weight of all the resin components in the insulating sheet
*2 The ratio in 100% by volume of the insulating sheet

### Examples 82 to 101 and Comparative Examples 17 to 20

Except that the types and amounts of the compounds were changed as shown in the following Tables 14 to 17, insulating materials were prepared in the same manner as in Example 1 and insulating sheets each were prepared on the PET film.

### Evaluations on Insulating Sheets of Examples 82 to 101 and Comparative Examples 17 to 20

The insulating sheet was evaluated for the aforementioned evaluation items (2) glass transition temperature, (3) thermal conductivity, (4) peel strength, (5) dielectric breakdown voltage, (6) solder heat resistance, and (7) reaction ratio. Further, the insulating sheet was evaluated for the following evaluation items (1-2) handleability, (9-2) self supportability, (10) heat dissipation capability, (11) bending modulus, and (12) elastic modulus.

### (1-2) Handleability

Except that the evaluation criteria of the handleability were changed as follows, the handleability was evaluated in the same manner as in the evaluation item (1) handleability.

### [Evaluation Criteria of Handleability]

oo (double circle): The insulating sheet was not deformed and was easily peeled off. Further, the insulating sheet had no tackiness. Thus, the insulating sheet was very easy to handle.

o: The insulating sheet was not deformed and was easily peeled off. The insulating sheet had a slight tackiness. Thus, the insulating sheet was required to be carefully handled.

Δ: The insulating sheet was peeled off, but the sheet was elongated or broken.

x: The insulating sheet was not peeled off.

### (9-2) Self Supportability

Except that the evaluation criteria of the self supportability were changed as follows, the self supportability was evaluated in the same manner as in the evaluation item (9) self supportability.

### [Evaluation Criteria of Self Supportability]

oo (double circle): The insulating sheet sagged downward and the sagging length (the degree of deformation) of the insulating sheet in the vertical direction was 1 cm or shorter.

o: The insulating sheet sagged downward and the sagging length (the degree of deformation) of the insulating sheet in the vertical direction was longer than 1 cm and no longer than 3 cm.

Δ: The insulating sheet sagged downward and the sagging length (the degree of deformation) of the insulating sheet in the vertical direction was longer than 3 cm and no longer than 5 cm.

x: The insulating sheet sagged downward and the sagging length (the degree of deformation) of the insulating sheet in the vertical direction was longer than 5 cm, or the insulating sheet tore.

### (10) Heat Dissipation Capability

The insulating sheet was sandwiched between a 1-mm thick aluminum plate and a 35-μm thick electrolytic copper foil. Then, the insulating sheet was press-cured at 120° C. for 1 hour and then at 200° C. for 1 hour while retaining a pressure at 4 MPa with a vacuum press to prepare a copper clad laminated plate. The copper foil surface of the prepared copper clad laminated plate was pressed to a flat-surface heat generator, with the temperature controlled to be 100° C. and having the same size as that of the laminated plate, at a pressure of 20 kgf/cm². The surface temperature of the aluminum plate was measured with a thermocouple, and the heat dissipation capability was evaluated according to the following criteria.

### [Evaluation Criteria of Heat Dissipation Capability]

oo (double circle): The temperature difference between the heat generator and the surface of the aluminum plate was within 3° C.

o: The temperature difference between the heat generator and the surface of the aluminum plate was higher than 3° C. and not higher than 6° C.

Δ: The temperature difference between the heat generator and the surface of the aluminum plate was higher than 6° C. and not higher than 10° C.

x: The temperature difference between the heat generator and the surface of the aluminum plate was higher than 10° C.

### (11) Bending Modulus

A sample piece (length: 8 cm, width: 1 cm, thickness: 4 mm) was subjected to a measurement at a span of 6 cm and at a rate of 1.5 mm/min with a universal tester RTC-1310A (produced by ORIENTEC Co., Ltd.) in accordance with JIS K 7111. Thus, the bending modulus at 25° C. of the uncured insulating sheet was measured.

Then, the insulating sheet was cured at 120° C. for 1 hour and then at 200° C. for 1 hour to provide a cured product of the insulating sheet. In the same manner as for the uncured insulating sheet, the sample piece (length: 8 cm, width: 1 cm, thickness: 4 mm) was subjected to a measurement at a span of 6 cm and at a rate of 1.5 mm/min with a universal tester (produced by ORIENTEC Co., Ltd.) in accordance with JIS K 7111. Thus, the bending modulus at 25° C. of the cured product of the insulating sheet was measured.

### (12) Elastic Modulus

A 2-cm diameter disc-shaped sample of the uncured insulating sheet was prepared, and the tan δ at 25° C. of the uncured insulating sheet was measured by means of a rotating dynamic viscoelasticity measuring apparatus VAR-100 (produced by REOLOGICA Instruments AB) with a 2-cm diameter parallel plate at a temperature of 25° C., an initial stress of 10 Pa, a frequency of 1 Hz, and a strain of 1% in an oscillation strain controlling mode. Further, the maximum value of tan δ of the insulating sheet when the uncured insulating sheet was heated from 25° C. to 250° C. was measured by heating the uncured insulating sheet sample from 25° C. to 250° C. at a heating rate of 30° C./min under the aforementioned conditions.

Tables 14 to 17 show the results.

TABLE 14

| | | | Examples | | | | | |
|---|---|---|---|---|---|---|---|---|
| | | | 82 | 83 | 84 | 85 | 86 | 87 |
| Components | Polymer (A) | Epoxy group-containing styrene resin | | | | | | 8 |
| (parts by | | Bisphenol A phenoxy resin | 8 | 5 | 10 | 12 | | |
| weight) | | Highly heat-resistant phenoxy resin | | | | | 8 | |
| | Polymer | Epoxy group-containing acryl resin 1 | | | | | | |
| | other than polymer (A) | | | | | | | |
| | Epoxy monomer (B1) | Bisphenol A liquid epoxy resin | 6 | 9 | 4 | 2 | 6 | 6 |
| | | Bisphenol F liquid epoxy resin | | | | | | |
| | | Trifunctional glycidyl diamine liquid | | | | | | |
| | | epoxy resin | | | | | | |
| | | Fluorene skeleton epoxy resin | | | | | | |
| | | Naphthalene skeleton liquid epoxy resin | | | | | | |
| | Oxetane monomer (B2) | Benzene skeleton oxetane resin | | | | | | |
| | Monomer | Hexahydro phthalate skeleton liquid | 2 | 2 | 2 | 2 | 2 | 2 |
| | other than monomer (B) | epoxy resin | | | | | | |
| | | Bisphenol A solid epoxy resin | | | | | | |
| | Curing agent (C) | Alicyclic skeleton acid anhydride | 2 | 2 | 2 | 2 | 2 | 2 |
| | | Aromatic skeleton acid anhydride | | | | | | |
| | | Polyalicyclic skeleton acid anhydride | | | | | | |
| | | Terpene skeleton acid anhydride | | | | | | |
| | | Biphenyl skeleton phenol resin | | | | | | |
| | | Allyl skeleton phenol resin | | | | | | |
| | | Triazine skeleton phenol resin | | | | | | |
| | | Melamine skeleton phenol resin | | | | | | |
| | | Isocyanurate-modified solid dispersed | 1 | 1 | 1 | 1 | 1 | 1 |
| | | imidazole | | | | | | |
| | Filler (D) | Surface-hydrophobic fumed silica | | | | | | |
| | | Spherical alumina | 80 | 80 | 80 | 80 | 80 | 80 |
| | | Boron nitride | | | | | | |
| | | Aluminum nitride | | | | | | |
| | Additive | Epoxy silane coupling agent | 1 | 1 | 1 | 1 | 1 | 1 |
| | Solvent | Methylethyl ketone | 20 | 20 | 20 | 20 | 20 | 20 |

| Ratio of polymer (A) (% by weight) *1 | | 40 | 25 | 50 | 60 | 40 | 40 |
|---|---|---|---|---|---|---|---|
| Ratio of monomer (B) (% by weight) *1 | | 30 | 45 | 20 | 10 | 30 | 30 |
| Ratio of filler (D) (% by volume) *2 | | 55 | 55 | 55 | 55 | 55 | 55 |
| Evaluations | Handleability of uncured sheet | ⊚ | ◯ | ⊚ | ⊚ | ⊚ | ◯ |
| | Self supportability of uncured sheet | ⊚ | ◯ | ⊚ | ⊚ | ⊚ | ◯ |
| | Handleability of cured sheet | ⊚ | ◯ | ⊚ | ⊚ | ⊚ | ⊚ |
| | Glass transition temperature (° C.) | 7 | 1 | 13 | 15 | 11 | 8 |
| | Thermal conductivity (W/m · K) | 2 | 2.2 | 2 | 1.9 | 2.2 | 2.1 |
| | Heat dissipation capability | ⊚ | ⊚ | ⊚ | ◯ | ⊚ | ◯ |
| | Peel strength (N/cm) | 19 | 22 | 15 | 14 | 17 | 18 |
| | Dielectric breakdown voltage (kV/mm) | 42 | 33 | 41 | 40 | 46 | 40 |
| | Solder heat resistance (288° C.) | ◯ | ◯ | ◯ | ◯ | ◯ | ◯ |
| | Reaction ratio (%) | 7 | 5 | 8 | 9 | 6 | 9 |
| | Bending modulus at 25° C. of uncured insulating sheet (MPa) | 50 | 11 | 490 | 780 | 100 | 19 |
| | Bending modulus at 25° C. of cured product of | 12,000 | 1,100 | 25,000 | 33,000 | 20,000 | 25,000 |
| | insulating sheet (MPa) | | | | | | |
| | Tanδ at 25° C. of uncured insulating sheet *3 | 0.4 | 0.8 | 0.2 | 0.1 | 0.3 | 0.6 |
| | Maximum value of tanδ at 25° C. to 250° C. of uncured | 3 | 4.8 | 1.6 | 1.1 | 2.8 | 1.3 |
| | insulating sheet *3 | | | | | | |

*1 The ratio in 100% by weight of all the resin components in the insulating sheet
*2 The ratio in 100% by volume of the insulating sheet
*3 Measured with a rotating dynamic viscoelasticity measuring apparatus

TABLE 15

| | | | Examples | | | | | |
|---|---|---|---|---|---|---|---|---|
| | | | 88 | 89 | 90 | 91 | 92 | 93 |
| Components | Polymer (A) | Epoxy group-containing styrene resin | | | | | | |
| (parts by weight) | | Bisphenol A phenoxy resin | 8 | 8 | 8 | 8 | 8 | 8 |
| | | Highly heat-resistant phenoxy resin | | | | | | |
| | Polymer | Epoxy group-containing acryl resin 1 | | | | | | |
| | other than polymer (A) | | | | | | | |
| | Epoxy monomer (B1) | Bisphenol A liquid epoxy resin | | | | | | 6 |
| | | Bisphenol F liquid epoxy resin | 6 | | | | | |
| | | Trifunctional glycidyl diamine liquid | | 6 | | | | |
| | | epoxy resin | | | | | | |
| | | Fluorene skeleton epoxy resin | | | 6 | | | |
| | | Naphthalene skeleton liquid | | | | 6 | | |
| | | epoxy resin | | | | | | |
| | Oxetane monomer (B2) | Benzene skeleton oxetane resin | | | | | 6 | |
| | Monomer | Hexahydro phthalate skeleton liquid | 2 | 2 | 2 | 2 | 2 | 2 |
| | other than monomer (B) | epoxy resin | | | | | | |
| | | Bisphenol A solid epoxy resin | | | | | | |
| | Curing agent (C) | Alicyclic skeleton acid anhydride | 2 | 2 | 2 | 2 | 2 | |
| | | Aromatic skeleton acid anhydride | | | | | | 2 |
| | | Polyalicyclic skeleton acid anhydride | | | | | | |
| | | Terpene skeleton acid anhydride | | | | | | |
| | | Biphenyl skeleton phenol resin | | | | | | |
| | | Allyl skeleton phenol resin | | | | | | |
| | | Triazine skeleton phenol resin | | | | | | |
| | | Melamine skeleton phenol resin | | | | | | |
| | | Isocyanurate-modified solid dispersed | 1 | 1 | 1 | 1 | 1 | 1 |
| | | imidazole | | | | | | |
| | Filler (D) | Surface-hydrophobic fumed silica | | | | | | |
| | | Spherical alumina | 80 | 80 | 80 | 80 | 80 | 80 |
| | | Boron nitride | | | | | | |
| | | Aluminum nitride | | | | | | |
| | Additive | Epoxy silane coupling agent | 1 | 1 | 1 | 1 | 1 | 1 |
| | Solvent | Methylethyl ketone | 20 | 20 | 20 | 20 | 20 | 20 |

| Ratio of polymer (A) (% by weight) *1 | | 40 | 40 | 40 | 40 | 40 | 40 |
|---|---|---|---|---|---|---|---|
| Ratio of monomer (B) (% by weight) *1 | | 30 | 30 | 30 | 30 | 30 | 30 |
| Ratio of filler (D) (% by volume) *2 | | 55 | 55 | 55 | 55 | 55 | 55 |
| Evaluations | Handleability of uncured sheet | ⊚ | ⊚ | ⊚ | ⊚ | ⊚ | ⊚ |
| | Self supportability of uncured sheet | ⊚ | ⊚ | ⊚ | ⊚ | ⊚ | ⊚ |
| | Handleability of cured sheet | ⊚ | ⊚ | ⊚ | ⊚ | ⊚ | ⊚ |
| | Glass transition temperature (° C.) | 4 | 5 | 10 | 8 | 11 | 12 |
| | Thermal conductivity (W/m · K) | 2.3 | 2.3 | 2.4 | 2.3 | 2.4 | 2.1 |
| | Heat dissipation capability | ⊚ | ⊚ | ⊚ | ⊚ | ⊚ | ◯ |
| | Peel strength (N/cm) | 20 | 20 | 18 | 20 | 23 | 17 |
| | Dielectric breakdown voltage (kV/mm) | 41 | 61 | 65 | 70 | 62 | 60 |
| | Solder heat resistance (288° C.) | ◯ | ◯ | ◯ | ◯ | ◯ | ◯ |
| | Reaction ratio (%) | 6 | 8 | 7 | 7 | 5 | 7 |
| | Bending modulus at 25° C. of uncured insulating sheet (MPa) | 35 | 40 | 120 | 60 | 40 | 320 |
| | Bending modulus at 25° C. of cured product of | 8,000 | 11,000 | 18,000 | 21,000 | 3,000 | 36,000 |
| | insulating sheet (MPa) | | | | | | |
| | Tanδ at 25° C. of uncured insulating sheet *3 | 0.5 | 0.3 | 0.3 | 0.4 | 0.3 | 0.2 |
| | Maximum value of tanδ at 25° C. to 250° C. of uncured | 3.6 | 2.5 | 2.4 | 3.2 | 3.8 | 1.3 |
| | insulating sheet *3 | | | | | | |

*1 The ratio in 100% by weight of all the resin components in the insulating sheet
*2 The ratio in 100% by volume of the insulating sheet
*3 Measured with a rotating dynamic viscoelasticity measuring apparatus

TABLE 16

| | | | Examples | | | | | |
|---|---|---|---|---|---|---|---|---|
| | | | 94 | 95 | 96 | 97 | 98 | 99 |
| Components | Polymer (A) | Epoxy group-containing styrene resin | | | | | | |
| (parts by | | Bisphenol A phenoxy resin | 8 | 8 | 8 | 8 | 8 | 8 |
| weight) | | Highly heat-resistant phenoxy resin | | | | | | |
| | Polymer | Epoxy group-containing aciyl resin 1 | | | | | | |
| | other than polymer (A) | | | | | | | |
| | Epoxy monomer (B1) | Bisphenol A liquid epoxy resin | 6 | 6 | 6 | 6 | 6 | 6 |
| | | Bisphenol F liquid epoxy resin | | | | | | |
| | | Trifunctional glycidyl diamine | | | | | | |
| | | liquid epoxy resin | | | | | | |
| | | Fluorene skeleton epoxy resin | | | | | | |
| | | Naphthalene skeleton liquid | | | | | | |
| | | epoxy resin | | | | | | |
| | Oxetane monomer (B2) | Benzene skeleton oxetane resin | | | | | | |
| | Monomer | Hexahydro phthalate skeleton liquid | 2 | 2 | 2 | 2 | 2 | 2 |
| | other than monomer (B) | epoxy resin | | | | | | |
| | | Bisphenol A solid epoxy resin | | | | | | |
| | Curing agent (C) | Alicyclic skeleton acid anhydride | | | | | | |
| | | Aromatic skeleton acid anhydride | | | | | | |
| | | Polyalicyclic skeleton acid anhydride | 2 | | | | | |
| | | Terpene skeleton acid anhydride | | 2 | | | | |
| | | Biphenyl skeleton phenol resin | | | 2 | | | |
| | | Allyl skeleton phenol resin | | | | 2 | | |
| | | Triazine skeleton phenol resin | | | | | 2 | |
| | | Melamine skeleton phenol resin | | | | | | 2 |
| | | Isocyanurate-modified solid dispersed | 1 | 1 | 1 | 1 | 1 | 1 |
| | | imidazole | | | | | | |
| | Filler (D) | Surface-hydrophobic fumed silica | | | | | | |
| | | Spherical alumina | 80 | 80 | 80 | 80 | 80 | 80 |
| | | Boron nitride | | | | | | |
| | | Aluminum nitride | | | | | | |
| | Additive | Epoxy silane coupling agent | 1 | 1 | 1 | 1 | 1 | 1 |
| | Solvent | Methylethyl ketone | 20 | 20 | 20 | 20 | 20 | 20 |

| Ratio of polymer (A) (% by weight) *1 | | 40 | 40 | 40 | 40 | 40 | 40 |
|---|---|---|---|---|---|---|---|
| Ratio of monomer (B) (% by weight) *1 | | 30 | 30 | 30 | 30 | 30 | 30 |
| Ratio of filler (D) (% by volume) *2 | | 55 | 55 | 55 | 55 | 55 | 55 |
| Evaluations | Handleability or uncured sheet | ⊚ | ⊚ | ⊚ | ◯ | ⊚ | ⊚ |
| | Self supportability of uncured sheet | ⊚ | ⊚ | ⊚ | ◯ | ⊚ | ⊚ |
| | Handleability of cured sheet | ⊚ | ⊚ | ⊚ | ⊚ | ⊚ | ⊚ |
| | Glass transition temperature (° C.) | 6 | 4 | 14 | 2 | 8 | 11 |
| | Thermal conductivity (W/m · K) | 2.4 | 2.4 | 2 | 2.1 | 2.2 | 2.4 |
| | Heat dissipation capability | ⊚ | ⊚ | ◯ | ⊚ | ⊚ | ⊚ |
| | Peel strength (N/cm) | 20 | 22 | 14 | 17 | 18 | 22 |
| | Dielectric breakdown voltage (kV/mm) | 66 | 68 | 62 | 57 | 59 | 63 |
| | Solder heat resistance (288° C.) | ◯ | ◯ | ◯ | ◯ | ◯ | ◯ |
| | Reaction ratio (%) | 7 | 6 | 8 | 9 | 7 | 7 |
| | Bending modulus at 25° C. of uncured insulating sheet (MPa) | 70 | 40 | 550 | 18 | 80 | 150 |
| | Bending modulus at 25° C. of cured product of | 18,000 | 15,000 | 38,000 | 20,000 | 15,000 | 18,000 |
| | insulating sheet (MPa) | | | | | | |
| | Tanδ at 25° C. of uncured insulating sheet *3 | 0.3 | 0.4 | 0.1 | 0.7 | 0.5 | 0.3 |
| | Maximum value of tanδ at 25° C. to 250° C. of uncured | 3.5 | 4.2 | 1 | 3.5 | 2.5 | 1.8 |
| | insulating sheet *3 | | | | | | |

*1 The ratio in 100% by weight of all the resin components in the insulating sheet
*2 The ratio in 100% by volume of the insulating sheet
*3 Measured with a rotating dynamic viscoelasticity measuring apparatus

TABLE 17

| | | | Examples | | Comparative Examples | | | |
|---|---|---|---|---|---|---|---|---|
| | | | 100 | 101 | 17 | 18 | 19 | 20 |
| Components | Polymer (A) | Epoxy group-containing styrene resin | | | | 14 | | |
| (parts by weight) | | Bisphenol A phenoxy resin | 12 | 10 | 2 | | | 8 |
| | | Highly heat-resistant phenoxy resin | | | | | | |
| | Polymer | Epoxy group-containing aciyl resin 1 | | | | | 8 | |
| | other than polymer (A) | | 9 | 7.5 | 10 | 3 | 6 | |
| | Epoxy monomer (B1) | Bisphenol A liquid epoxy resin | | | | | | |
| | | Bisphenol F liquid epoxy resin | | | | | | |
| | | Trifunctional glycidyl diamine liquid epoxy resin | | | | | | |
| | | Fluorene skeleton epoxy resin | | | | | | |
| | | Naphthalene skeleton liquid epoxy resin | | | | | | |
| | Oxetane monomer | Benzene skeleton oxetane resin | | | | | | |
| | (B2) | | | | | | | |
| | Monomer other | Hexahydro phthalate skeleton liquid epoxy resin | 3 | 2.5 | 4 | | 2 | 2 |
| | than monomer (B) | Bisphenol A solid epoxy resin | | | | | | 6 |
| | Curing agent (C) | Alicyclic skeleton acid anhydride | 3 | 2.5 | 2 | 1 | 2 | 2 |
| | | Aromatic skeleton acid anhydride | | | | | | |
| | | Polyalicyclic skeleton acid anhydride | | | | | | |
| | | Terpene skeleton acid anhydride | | | | | | |
| | | Biphenyl skeleton phenol resin | | | | | | |
| | | Allyl skeleton phenol resin | | | | | | |
| | | Triazine skeleton phenol resin | | | | | | |
| | | Melamine skeleton phenol resin | | | | | | |
| | | Isocyanurate-modified solid dispersed imidazole | 1.5 | 1.25 | 1 | 1 | 1 | 1 |
| | Filler (D) | Surface-hydrophobic fumed silica | | | | 10 | | |
| | | Spherical alumina | | | 80 | 70 | 80 | 80 |
| | | Boron nitride | 70 | | | | | |
| | | Aluminum nitride | | 75 | | | | |
| | Additive | Epoxy silane coupling agent | 1.5 | 1.25 | 1 | 1 | 1 | 1 |
| | Solvent | Methylethyl ketone | 20 | 20 | 20 | 20 | 20 | 20 |

| Ratio of polymer (A) (% by weight) *1 | | 40 | 40 | 10 | 70 | — | 40 |
|---|---|---|---|---|---|---|---|
| Ratio of monomer (B) (% by weight) *1 | | 30 | 30 | 50 | 15 | 30 | — |
| Ratio of filler (D) (% by volume) *2 | | 55 | 55 | 55 | 45 | 55 | 55 |
| Evaluations | Handleability or uncured sheet | ⊚ | ⊚ | X | ⊚ | X | X |
| | Self supportability of uncured sheet | ⊚ | ⊚ | X | ⊚ | X | — |
| | Handleability of cured sheet | ⊚ | ⊚ | ◯ | ◯ | — | — |
| | Glass transition temperature (° C.) | 6 | 5 | −10 | 23 | — | 33 |
| | Thermal conductivity (W/m · K) | 3.4 | 4.2 | — | 1.6 | — | — |
| | Heat dissipation capability | ⊚ | ⊚ | — | X | — | — |
| | Peel strength (N/cm) | 14 | 18 | — | 8 | — | — |
| | Dielectric breakdown voltage (kV/mm) | 42 | 53 | — | 28 | — | — |
| | Solder heat resistance (288° C.) | ◯ | ◯ | — | ◯ | — | — |
| | Reaction ratio (%) | 7 | 7 | 4 | 11 | 8 | 13 |
| | Bending modulus at 25° C. of uncured insulating sheet (MPa) | 120 | 35 | 0.8 | 1,500 | — | — |
| | Bending modulus at 25° C. of cured product of insulating sheet (MPa) | 15,000 | 8,000 | 35,000 | 51,000 | — | — |
| | Tanδ at 25° C. of uncured insulating sheet *3 | 0.2 | 0.5 | 0.6 | 0.03 | — | — |
| | Maximum value of tanδ at 25° C. to 250° C. of uncured insulating sheet *3 | 1.5 | 3.9 | 8 | 0.3 | — | — |

*1 The ratio in 100% by weight of all the resin components in the insulating sheet
*2 The ratio in 100% by volume of the insulating sheet
*3 Measured with a rotating dynamic viscoelasticity measuring apparatus

1. An insulating sheet used for bonding a heat conductor having a thermal conductivity of 10 W/m·K or higher to an electrically conductive layer, comprising:
(A) a polymer having an aromatic skeleton and a weight average molecular weight of 10,000 or more;
(B) at least one of an epoxy monomer (B1) having an aromatic skeleton and a weight average molecular weight of 600 or less and an oxetane monomer (B2) having an aromatic skeleton and a weight average molecular weight of 600 or less;
(C) a curing agent composed of a phenol resin, an acid anhydride having an aromatic skeleton or an alicyclic skeleton, a hydrogenated product of the acid anhydride, or a modified product of the acid anhydride; and
(D) a filler,
wherein
the insulating sheet contains 20 to 60% by weight of the polymer (A) and 10 to 60% by weight of the monomer (B) in 100% by weight of all resin components including the polymer (A), the monomer (B), and the curing agent (C) so that the total amount of the polymer (A) and the monomer (B) is less than 100% by weight,
when the insulating sheet is uncured, the insulating sheet has a glass transition temperature Tg of 25° C. or lower, and
after the insulating sheet is cured, a cured product of the insulating sheet has a dielectric breakdown voltage of 30 kV/mm or higher.

2. The insulating sheet according to claim 1,
wherein
the polymer (A) is a phenoxy resin.

3. The insulating sheet according to claim 2,
wherein
the phenoxy resin has a glass transition temperature Tg of 95° C. or higher.

4. The insulating sheet according claim 1,
wherein
the curing agent (C) is a first acid anhydride having a polyalicyclic skeleton, a hydrogenated product of the first acid anhydride, or a modified product of the first acid anhydride, or a second acid anhydride having an alicyclic skeleton formed by addition reaction between a terpene compound and maleic anhydride, a hydrogenated product of either of the acid anhydride, or a modified product of either of the acid anhydride.

5. The insulating sheet according to claim 4,
wherein
the curing agent (C) is an acid anhydride represented by any one of formulas (1) to (3): 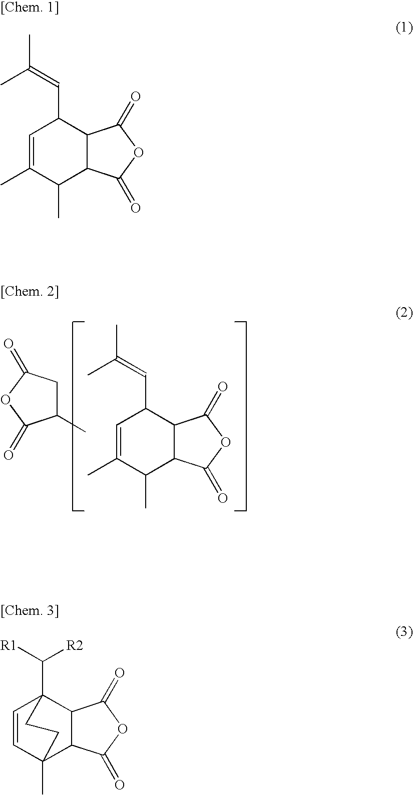
wherein R1 and R2 each represent hydrogen, a C1-C5 alkyl group, or a hydroxy group.

6. The insulating sheet according to claim 1,
wherein
the curing agent (C) is a phenol resin having a melamine skeleton or a triazine skeleton, or a phenol resin having an allyl group.

7. The insulating sheet according to claim 1,
wherein
the filler (D) contains:
a spherical filler (D1) having an average particle size of 0.1 to 0.5 μm;
a spherical filler (D2) having an average particle size of 2 to 6 μm; and
a spherical filler (D3) having an average particle size of 10 to 40 μm, and
the filler (D) contains 5 to 30% by volume of the spherical filler (D1), 20 to 60% by volume of the spherical filler (D2), and 20 to 60% by volume of the spherical filler (D3) in 100% by volume of the filler (D) so that the total amount of the spherical filler (D1), the spherical filler (D2), and the spherical filler (D3) is not more than 100% by volume.

8. The insulating sheet according to claim 1,
wherein
the filler (D) is a crushed filler (D4) having an average particle size of 12 μm or smaller.

9. The insulating sheet according to claim 1,
wherein
the filler (D) is at least one selected from the group consisting of alumina, boron nitride, aluminum nitride, silicon nitride, silicon carbide, zinc oxide, and magnesium oxide.

10. The insulating sheet according to claim 1, further comprising
a dispersing agent (F),
wherein
the dispersing agent (F) has a functional group containing a hydrogen atom capable of forming a hydrogen bond.

11. The insulating sheet according to further comprising
granular rubber (E).

12. The insulating sheet according to claim 11,
wherein
the granular rubber (E) is granular silicone rubber.

13. The insulating sheet according to claim 1,
wherein
the polymer (A) contains 30 to 80% by weight of the aromatic skeleton in 100% by weight of the whole polymer skeleton.

14. The insulating sheet according to claim 1,
wherein
the polymer (A) has a polycyclic aromatic skeleton in a main chain.

15. The insulating sheet according to claim 1, being free from glass cloth.

16. The insulating sheet according to claim 1,
wherein
when the insulating sheet is uncured, the insulating sheet has a bending modulus at 25° C. of 10 to 1,000 MPa,
after the insulating sheet is cured, a cured product of the insulating sheet has a bending modulus at 25° C. of 100 to 50,000 MPa, and
when the insulating sheet is uncured, the insulating sheet has a tan δ of 0.1 to 1.0 at 25° C., and when the uncured insulating sheet is heated from 25° C. to 250° C., the insulating sheet has a maximum tan δ of 1.0 to 5.0, each of the tan δ measured with a rotating dynamic viscoelasticity measuring apparatus.

17. The insulating sheet according to claim 1,
wherein
when the insulating sheet is uncured, the insulating sheet has a reaction ratio of 10% or lower.

18. A multilayer structure, comprising:
a heat conductor having a thermal conductivity of 10 W/m·K or higher;
an insulating layer laminated on at least one side of the heat conductor; and
an electrically conductive layer laminated on the insulating layer on the other side of the insulating layer,
wherein
the insulating layer is formed by curing the insulating sheet according to claim 1.

19. The multilayer structure according to claim 18,
wherein
the heat conductor is made of a metal.
